(19) United States
(12) Patent Application Publication
(10) Pub. No.: US 2004/0240055 A1
(43) Pub. Date: Dec. 2, 2004

(54) Rear projection screen and projection display apparatus

(75) Inventors: Kohei Teramoto, Tokyo (JP); Kuniko Kojima, Tokyo (JP); Kimihide Nakatsu, Tokyo (JP); Sadakazu Tomita, Tokyo (JP); Shigeto Maejima, Tokyo (JP); Teruo Miyamoto, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/813,197

(22) Filed: Mar. 31, 2004

(30) Foreign Application Priority Data
May 28, 2003 (JP) 2003-150466
Nov. 21, 2003 (JP) 2003-391994

(51) Int. Cl. G03B 21/60

(52) U.S. Cl. 359/457

(57) ABSTRACT

A rear projection screen of the type which allows a projected light beam incident thereon to pass therethrough to a viewer side includes a Fresnel lens sheet, and a lenticular lens plate opposed to the Fresnel lens sheet. The Fresnel lens sheet is in the form of a thin sheet made of a resin, and converts the projected light beam incident thereon into substantially collimated light to direct the substantially collimated light outwardly toward the viewer side. The lenticular lens plate refracts the projected light beam incident thereon horizontally or vertically.

### BACKGROUND OF THE INVENTION

1. Field of the Invention

The present invention relates to a rear projection screen for use in a projection display apparatus employing a light valve, such as a digital micromirror device, a transmissive liquid crystal panel and a reflective liquid crystal panel, and a projection display apparatus using the rear projection screen.

2. Description of the Background Art

A conventional rear projection screen includes a Fresnel lens screen made of an acrylic resin and having a flat surface located on the projected light beam incident side (from which a projected light beam is incident on the rear projection screen), a first lenticular lens screen made of an acrylic resin for vertically distributing the light beam, and a second lenticular lens screen made of an acrylic resin for horizontally distributing the light beam (as disclosed in Japanese Patent Application Laid-Open No. 2001-42427, paragraph 0030 and FIG. 3).

In the above-mentioned conventional rear projection screen, however, the Fresnel lens screen, which is constructed by a plate-like member made of resin, has an increased thickness. This increases the influence of stray light components which do not correctly pass through the Fresnel lens screen but are reflected several times in the Fresnel lens screen and then exit from the Fresnel lens screen in a position distant from a real image to a viewer side. (The principle of occurrence of image degradation due to the stray light components will be described in detail later in the preferred embodiments.)

Further, in the above-mentioned conventional rear projection screen, there is a likelihood that the lens screens undergo warpage which impairs the flatness of the lens screens. Such warpage of the lens screens becomes a cause of the degradation of the quality of images (which will be also described in detail later in the preferred embodiments).

### SUMMARY OF THE INVENTION

It is a first object of the present invention to provide a rear projection screen and a projection display apparatus capable of reducing the influence of stray light resulting from undesired reflection in a lens sheet to improve image quality.

It is a second object of the present invention to provide a rear projection screen and a projection display apparatus capable of reducing the amount of warpage of a lens sheet under the influence of temperature and humidity and the like to improve image quality.

According to a first aspect of the present invention, a rear projection screen for allowing a projected light beam incident thereon to pass therethrough to a viewer side includes a horizontal lenticular lens plate, a Fresnel lens sheet, and a securing fixture. The Fresnel lens sheet includes a first resin substrate, and a Fresnel lens formed on a first surface of the first resin substrate and serving to concentrate the projected light beam on the viewer side. The Fresnel lens sheet is located on an incident side of the horizontal lenticular lens plate, the incident side being the side from which the projected light beam is incident on the rear projection screen. The horizontal lenticular lens plate includes a substrate member in plate-like form made of a highly rigid, light-transmittable material, and a horizontal lenticular lens sheet disposed in superposed relation with the substrate member. The horizontal lenticular lens sheet includes a second resin substrate, and a horizontal lenticular lens formed on a first surface of the second resin substrate and serving to horizontally refract incident light. The securing fixture fixes the Fresnel lens sheet and the horizontal lenticular lens plate together.

The horizontal lenticular lens plate having high rigidity is formed by bonding the horizontal lenticular lens sheet to the substrate member in the plate-like form made of the highly rigid material. The Fresnel lens sheet is fixed to the horizontal lenticular lens plate by the securing fixture. This reduces the thickness of the Fresnel lens sheet without the decrease in rigidity (strength) of the rear projection screen, to reduce the influence of stray light resulting from undesired reflection in the Fresnel lens sheet, thereby improving image quality.

According to a second aspect of the present invention, a rear projection screen for allowing a projected light beam incident thereon to pass therethrough to a viewer side includes a Fresnel lens sheet, and a lenticular lens plate opposed to the Fresnel lens sheet. The Fresnel lens sheet is in the form of a thin sheet made of a resin, and converts the projected light beam incident thereon into substantially collimated light to direct the substantially collimated light outwardly toward the viewer side. The lenticular lens plate refracts the projected light beam incident thereon horizontally or vertically.

The Fresnel lens sheet, which is in the form of a thin sheet made of a resin, reduces the influence of stray light resulting from undesired reflection in the Fresnel lens sheet, to improve image quality.

Additionally, thinning the Fresnel lens sheet reduces the coefficient of linear expansion of the Fresnel lens sheet to as low as that of metal. This prevents image quality degradation due to the influence of warpage of the Fresnel lens sheet resulting from a thermal expansion difference between a metal frame and the Fresnel lens sheet when the metal frame holds the Fresnel lens sheet.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view, with portions broken away, of a rear projection screen as viewed from the viewer side according to a first preferred embodiment of the present invention;

FIG. 2 is a horizontal sectional view taken along the line A-A of FIG. 1;

FIG. 3 is a horizontal sectional view showing a partial construction of a horizontal lenticular lens sheet shown in FIG. 1;

FIG. 4 is a sectional view showing a partial construction of a Fresnel lens sheet shown in FIG. 1;

FIG. 5 is an enlarged view of a portion of a Fresnel lens shown in FIG. 4 corresponding to one pitch;

FIG. 6 is a sectional view of principal parts of the rear projection screen of FIG. 1;

FIG. 7 is a schematic side view of a projection display apparatus of an angled projection type in which the rear projection screen of FIG. 1 is used;

FIG. 8 is a schematic side view of a projection display apparatus of a central projection type as contrasted with the projection display apparatus of FIG. 7;

FIG. 9 conceptually shows the angle of incidence of a projected light beam on a rear projection screen in the projection display apparatus of FIG. 7;

FIG. 10 conceptually shows the angle of incidence of a projected light beam on a rear projection screen in the projection display apparatus of FIG. 8;

FIG. 11 illustrates the principle of the occurrence of a problem under the influence of temperature and humidity in the projection display apparatus of FIG. 7;

FIG. 12 illustrates the principle of the occurrence of a problem under the influence of stray light components in the projection display apparatus of FIG. 7;

FIG. 13 is a horizontal sectional view of the rear projection screen according to a second preferred embodiment of the present invention;

FIG. 14 is a front view of principal parts of the rear projection screen of FIG. 13;

FIG. 15 is an exploded perspective view of the rear projection screen according to a third preferred embodiment of the present invention;

FIG. 16 is a perspective view, with portions broken away, schematically showing the arrangement of lens elements of the rear projection screen of FIG. 15;

FIG. 17 is a horizontal sectional view schematically showing the arrangement of the lens elements of the rear projection screen of FIG. 15;

FIG. 18 is a sectional view showing the construction of an upper edge portion of the rear projection screen of FIG. 15;

FIG. 19 is a perspective view showing the construction of an upper retaining member and the like for use in the rear projection screen of FIG. 15;

FIG. 20 is a sectional view showing the construction of a lower edge portion of the rear projection screen of FIG. 15;

FIG. 21 is a perspective view showing the construction of a lower elastic member and the like for use in the rear projection screen of FIG. 15;

FIG. 22 is a sectional view showing the construction of a left-hand edge portion of the rear projection screen of FIG. 15;

FIG. 23 is a perspective view showing the construction of a right-hand elastic member and the like for use in the rear projection screen of FIG. 15;

FIG. 24 is a side view showing the construction of the lower elastic member for use in the rear projection screen of FIG. 15;

FIG. 25 is a side view-showing the construction of a left-hand elastic member for use in the rear projection screen of FIG. 15;

FIG. 26 illustrates the principle of the occurrence of a problem under the influence of stray light components in the projection display apparatus;

FIG. 27 illustrates the principle of the occurrence of a problem under the influence of temperature and humidity in the projection display apparatus;

FIG. 28 is a perspective view of the lower elastic member for use in the rear projection screen according to a fifth preferred embodiment of the present invention;

FIG. 29 is a perspective view of the right-hand elastic member for use in the rear projection screen according to the firth preferred embodiment of the present invention;

FIG. 30 is a perspective view showing the construction of a right-hand mounting portion of the Fresnel lens sheet in the rear projection screen according to a sixth preferred embodiment of the present invention;

FIG. 31 is a sectional view showing the construction of a left-hand mounting portion of the Fresnel lens sheet in the rear projection screen according to the sixth preferred embodiment of the present invention;

FIG. 32 is a perspective view showing the construction of the right-hand mounting portion of the Fresnel lens sheet in the rear projection screen according to a seventh preferred embodiment of the present invention; and

FIG. 33 is a sectional view showing the construction of the left-hand mounting portion of the Fresnel lens sheet in the rear projection screen according to the seventh preferred embodiment of the present invention.

### DESCRIPTION OF THE PREFERRED EMBODIMENTS

### First Preferred Embodiment

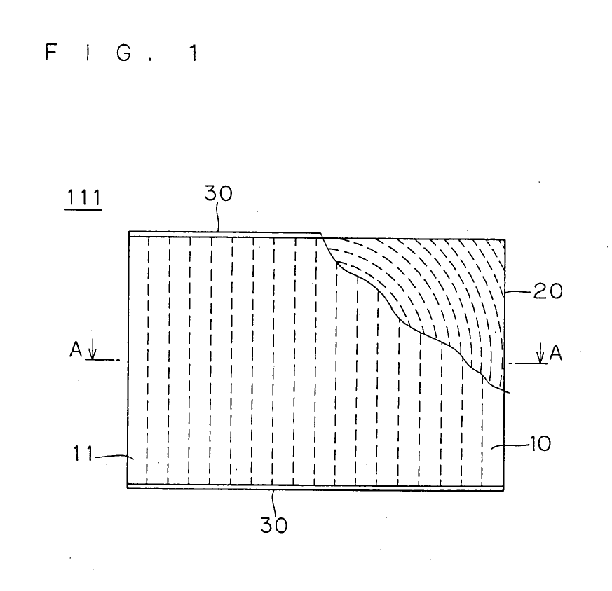

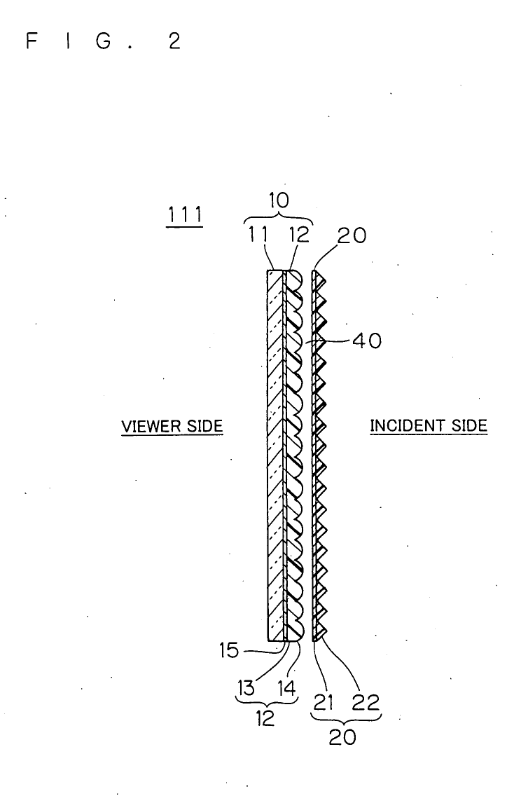

FIG. 1 is a front view, with portions broken away, of a rear projection screen as viewed from the viewer side according to a first preferred embodiment of the present invention. FIG. 2 is a horizontal sectional view taken along the line A-A of FIG. 1. The rear projection screen 111 according to the first preferred embodiment includes a horizontal lenticular lens plate 10 and a Fresnel lens sheet 20, as shown in FIGS. 1 and 2.

The horizontal lenticular lens plate 10 includes a front plate (base plate member) 11 formed by a glass substrate, and a horizontal lenticular lens sheet 12 having a property of refracting incident light in a horizontal direction, the front plate 11 and the horizontal lenticular lens sheet 12 being bonded together. The horizontal lenticular lens sheet 12 includes a resin substrate 13 in sheet form, and a horizontal lenticular lens 14 formed on one surface of the resin substrate 13. The horizontal lenticular lens sheet 12 is bonded to the front plate 11 with a clear adhesive 15 so that a flat surface of the horizontal lenticular lens sheet 12 opposite from a surface (lens surface) provided with the lens 14 is opposed to the front plate 11. The horizontal lenticular lens 14 includes a plurality of lens portions 14a (See FIG. 3) each extending vertically and having a substantially convex sectional configuration.

The horizontal lenticular lens 14 is formed, for example, by placing the resin substrate 13 produced previously and an ultraviolet curable resin on a metal mold for lens formation and performing ultraviolet irradiation to cure the ultraviolet curable resin. The resin substrate 13 is formed of, for example, polyethylene terephthalate (PET), polystyrene resin, polycarbonate resin, acrylic resin, or the like. The method of forming the horizontal lenticular lens 14 is not limited to that using the ultraviolet curable resin, but may be a method using an extrusion process.

A plurality of black light-blocking layers 16 in the form of stripes extending in a direction in which the lens portions 14a of the horizontal lenticular lens 14 extend are provided on the flat surface of the horizontal lenticular lens sheet 12, as shown in FIG. 3. The black light-blocking layers 16 are in corresponding relation to the respective lens portions 14a of the horizontal lenticular lens 14, and are located in other regions of the flat surface of the sheet 12 than regions (light collecting portions) through which light (a projected light beam 115) correctly collected by the lens portions 14a passes. The black light-blocking layers 16 effectively block incident light passing through the horizontal lenticular lens sheet 12 except the projected light beam 115 correctly collected by the lens portions 14a, to achieve improvements in display image contrast and the like.

The projected light beam 115 incident on the horizontal lenticular lens sheet 12 is refracted and collected by the lens portions 14a and then diffused in the horizontal direction, as shown in FIG. 3.

In the first preferred embodiment, a light diffusing material is mixed in the adhesive 15 (or a bonding layer) for bonding the horizontal lenticular lens sheet 12 and the front plate 11 together. The mixed light diffusing material effectively diffuses the projected light beam 115 in all directions, thereby to increase the viewing angle of the screen 111 not only horizontally but also vertically without the need to use a vertical lenticular lens. The first preferred embodiment may be modified so that the light diffusing material is mixed in the horizontal lenticular lens sheet 12 or in the Fresnel lens sheet 20, rather than in the bonding layer (15), or so that the light diffusing material is mixed in at least two of the bonding layer (15), the horizontal lenticular lens sheet 12 and the Fresnel lens sheet 20.

At least one surface of the horizontal lenticular lens plate 10 is subjected to at least one of a hard coating process, an antistatic process, and an anti-reflection process.

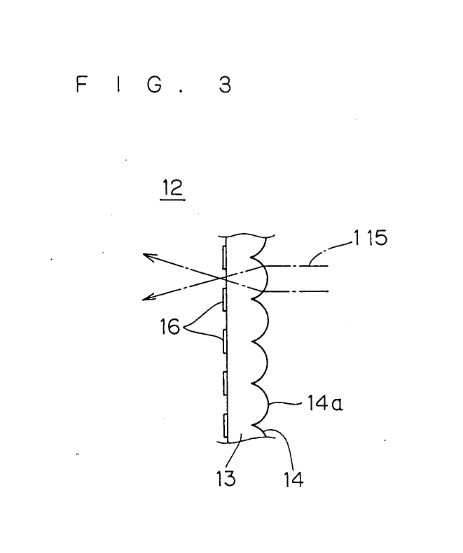

The Fresnel lens sheet 20 includes a resin substrate 21 in sheet form, and a Fresnel lens 22 formed on one surface of the resin substrate 21, as shown in FIGS. 2 and 4. The Fresnel lens 22 is formed, for example, by placing the resin substrate 21 produced previously and an ultraviolet curable resin on a metal mold for lens formation and performing ultraviolet irradiation to cure the ultraviolet curable resin. The resin substrate 21 is formed of, for example, polyethylene terephthalate (PET), polystyrene resin, polycarbonate resin, or the like. The method of forming the Fresnel lens 22 is not limited to that using the ultraviolet curable resin, but may be a method using an extrusion process.

As shown in FIGS. 4 and 5, the Fresnel lens 22 includes a plurality of refraction and total reflection structures 25 arranged at a predetermined pitch (or spacing) P and including concentric refraction Fresnel lens portions 23 and concentric total reflection Fresnel lens portions 24, respectively. Each of the refraction Fresnel lens portions 23 has a combination of a refraction slope 26 for refracting the projected light beam 115 incident thereon, and an inoperative facet 27 located adjacent to and on the inner peripheral side of the refraction slope 26. Each of the total reflection Fresnel lens portions 24 has a combination of a transparent slope 28 allowing the projected light beam 115 to pass through, and a total reflection slope 29 for totally reflecting the projected light beam 115 having passed through the transparent slope 28.

The construction and position of the Fresnel lens 22 in the Fresnel lens sheet 20 must be selected to efficiently utilize light depending on the construction of a projection display apparatus to which the rear projection screen 111 is applied.

Although the refraction Fresnel lens portions 23 and the total reflection Fresnel lens portions 24 are used to constitute the Fresnel lens 22 in the first preferred embodiment, either the refraction Fresnel lens portions 23 or the total reflection Fresnel lens portions 24 may constitute the Fresnel lens 22.

Although located on the light incident side of the Fresnel lens sheet 20 in the first preferred embodiment, the Fresnel lens 22 may be located on the light exit side of the Fresnel lens sheet 20. In this case, the Fresnel lens 22 may be constructed by only the total reflection Fresnel lens portions 24, by only the refraction Fresnel lens portions 23, or by the combination of the total reflection Fresnel lens portions 24 and the refraction Fresnel lens portions 23.

The projected light beam 115 incident on the Fresnel lens 22 is converted into substantially collimated light by the lens action of the Fresnel lens 22.

In the first preferred embodiment, at least one surface of the Fresnel lens sheet 20 is subjected to an anti-reflection process.

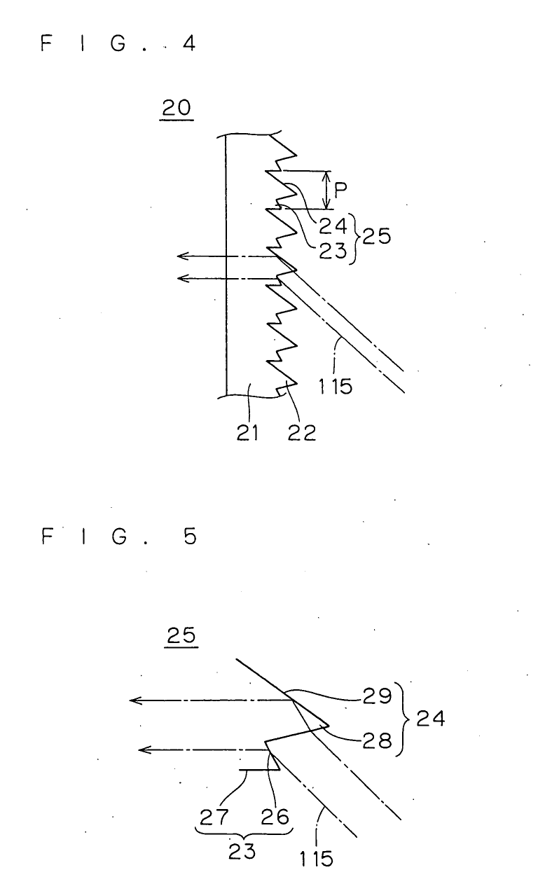

As shown in FIGS. 1 and 6, the horizontal lenticular lens plate 10 and the Fresnel lens sheet 20 are fixed together by a pair of metal frame members 30 serving as a securing fixture. When fixed together, the horizontal lenticular lens plate 10 and the Fresnel lens sheet 20 are opposed to each other with a clearance 40 between the lens surface of the horizontal lenticular lens plate 10 on which the horizontal lenticular lens 14 is provided and the flat surface of the Fresnel lens sheet 20. The clearance 40 is provided to form an air space between the horizontal lenticular lens plate 10 and the Fresnel lens sheet 20.

The pair of metal frame members 30 fix the horizontal lenticular lens plate 10 and the Fresnel lens sheet 20 together at their upper and lower edges in the first preferred embodiment. Instead, the pair of metal frame members 30 may fix the left-hand and right-hand edges of the horizontal lenticular lens plate 10 and the Fresnel lens sheet 20. Alternatively, one or more metal frame members 30 may be used to fix the horizontal lenticular lens plate 10 and the Fresnel lens sheet 20 throughout their peripheries, i.e. the upper, lower, left-hand and right-hand edges thereof.

The specific construction and fixing form of the metal frame members 30 may be of various types. An example of the various types is shown in FIG. 6. In the construction shown in FIG. 6, the substantially plate-like metal frame members 30 are fixed to the upper and lower edge surfaces of the horizontal lenticular lens plate 10 with an adhesive 31, and the upper and lower edge portions of the Fresnel lens sheet 20 are fixed to the metal frame members 30 with screws 32, nuts 33 and the like. In this case, a fixing portion 20a extending in a direction perpendicular to the body portion of the Fresnel lens sheet 20 and toward the incident side (from which the projected light beam 115 is incident on the screen 111) is provided on each of the upper and lower edge portions of the Fresnel lens sheet 20, and the fixing portion 20a is fixed to each of the metal frame members 30 with the screws 32 and the like.

In such a fixed condition, the Fresnel lens sheet 20 is placed under a predetermined tension so as to be parallel to the horizontal lenticular lens plate 10 with the predetermined clearance 40 therebetween. Thus, the Fresnel lens sheet 20 is fixed in a flat configuration to the horizontal lenticular lens plate 10.

The metal material of the metal frame members 30 and the resin material of the resin substrate 21 of the Fresnel lens sheet 20 are selected to have coefficients of linear expansion close to each other. In practice, after the metal material of the metal frame members 30 is determined, a resin material having a coefficient of linear expansion close to that of the metal material is selected as the material of the resin substrate 21. Specifically, when aluminum is adopted, for example, as the material of the metal frame members 30, polyethylene terephthalate (PET) is adopted as the material of the resin substrate 21. The coefficient of linear expansion of aluminum is 23×10⁻⁶/K and the coefficient of linear expansion of polyethylene terephthalate (PET) is 25×10⁻⁶/K, both of which are closely analogous to each other.

Thus, if the metal frame members 30 and the Fresnel lens sheet 20 expand under the influence of temperature and humidity, the metal frame members 30 and the Fresnel lens sheet 20 are substantially equal in the amount of deformation. This prevents the warpage or the like of the Fresnel lens sheet 20.

The rear projection screen 111 having such a construction is located so that the front plate 11 of the horizontal lenticular lens plate 10 faces the viewer side.

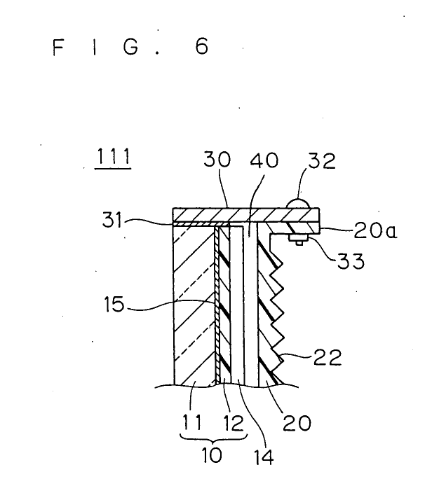

FIG. 7 is a schematic view of a projection display apparatus 110 of an angled projection type in which the rear projection screen 111 of FIG. 1 is used. The projection display apparatus 110 employs a reflective light valve (not shown). In the projection display apparatus 110, as illustrated in FIG. 7, the light beam 115 emitted from a projection optical system 112 is reflected from a reflecting mirror 113, and then directed upwardly onto a plane mirror 114. Thereafter, the light beam 115 is reflected from the plane mirror 114, and then enters the rear projection screen 111. The light beam 115 incident on the rear projection screen 111 is converted into substantially collimated light by the Fresnel lens sheet 20 provided in the screen 111. The collimated light is diffused horizontally by the horizontal lenticular lens sheet 12 to exit through the front plate 11 to the viewer side. The light diffusing material mixed in the bonding layer (15) between the horizontal lenticular lens sheet 12 and the front plate 11 also diffuses the light beam 115 in all directions.

The reflecting mirror 113 may be of aspherical configuration so as to widely spread out the projected light beam 115 reflected therefrom while suppressing the degradation of aberration characteristics thereof.

Although the plane mirror 114 is placed in parallel to the screen 111 for the purpose of reducing the thickness of the projection display apparatus 110 in the first preferred embodiment, the plane mirror 114 may be slightly angled with respect to the rear projection screen 111. Such a type of projection in which the optical axis of a light beam projected onto the screen 111 is angled with respect to the normal to the screen 111 is referred to as the “angled projection type.”

The rear projection screen 111 according to the first preferred embodiment is applicable to a projection display apparatus 110A of a central projection type shown in FIG. 8. The projection display apparatus 110A is commonly used, and is designed so that the plane mirror 114 is placed at an angle of 45 degrees with respect to the normal to the rear projection screen 111. In the projection display apparatus 110A, therefore, the light beam 115 emitted from the projection optical system 112 upwardly toward the plane mirror 114 is reflected from the plane mirror 114 to enter the rear projection screen 111 in a direction at right angles to the rear projection screen 111. Then, the light beam 115 passes through the rear projection screen 111 to exit to the viewer side.

It will be understood also from FIG. 8 that the projection display apparatus 110A of the central projection type, however, requires the plane mirror 114 of large area, and has a characteristic such that it is difficult to achieve the reduction in thickness of the projection display apparatus 110A as compared with the projection display apparatus 110 of FIG. 7 because of the plane mirror 114 is angled.

Although the plane mirror 114 is placed at the angle of 45 degrees with respect to the normal to the rear projection screen 111 in the projection display apparatus 110A of FIG. 8, the angle is not particularly limited to 45 degrees, but may be, for example, 40 degrees.

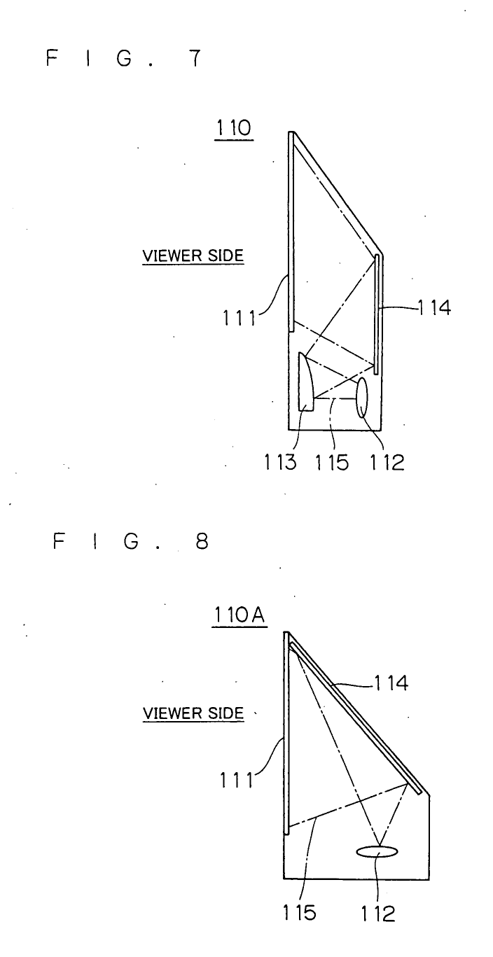

FIG. 9 conceptually shows the angle of incidence of the projected light beam 115 on the rear projection screen 111 in the projection display apparatus 110 of FIG. 7. FIG. 10 conceptually shows the angle of incidence of the projected light beam 115 on the rear projection screen 111 in the projection display apparatus 110A of FIG. 8. Although the projection display apparatuses 110 and 110A are actually designed so that the projected light beam 115 is turned back by the use of the plane mirror 114, the light beam 115 is shown in FIGS. 9 and 10 as projected directly from the projection optical system 112 onto the rear projection screen 111 for the purpose of schematically obtaining the angle of incidence on the rear projection screen 111.

In the construction of FIG. 9, the reference character W designates the horizontal dimension of the rear projection screen 111; H designates the vertical dimension of the rear projection screen 111; S designates the shortest distance from a point lying on the projection optical axis of the projection optical system 112 to the lower edge of the rear projection screen 111; and L designates a distance along the projection optical axis from a position spaced the distance S apart from the lower edge of the rear projection screen 111 to the pupil of the projection optical system 112. Under these conditions, the following angles of incidence are determined: a first angle of incidence θ1 of the projected light beam 115 exiting from the pupil position of the projection optical system 112 onto the center of the rear projection screen 111; a second angle of incidence θ2 thereof onto the upper-left and upper-right corners of the rear projection screen 111 (although the second angle of incidence θ2 onto only the upper-right corner is shown in FIG. 9); and an third angle of incidence θ3 thereof onto the middle of the lower edge of the rear projection screen 111. At this time, the first angle of incidence θ1 is greater than 0 degrees, and the second angle of incidence θ2 is the maximum angle of incidence of the light beam 115 onto the screen 111 whereas the third angle of incidence θ3 is the minimum angle of incidence of the light beam 115 onto the screen 111.

In the construction shown in FIG. 10, the projection optical axis of the projection optical system 112 coincides with the center of the rear projection screen 111 because of the use of the central projection type. A fourth angle of incidence θ4 of the projected light beam 115 exiting from the pupil position of the projection optical system 112 spaced the distance L from the screen 111 onto the center of the rear projection screen 111 is the minimum angle of incidence (0 degrees). The angle of incidence of the projected light beam 115 onto each of the four corners of the screen 111 is the maximum angle of incidence θ5 on the rear projection screen 111.

The angle of incidence θ1 on the center, the minimum angle of incidence θ2 and the maximum angle of incidence θ3 in the construction shown in FIG. 9, and the maximum angle of incidence θ5 in the construction shown in FIG. 10 are calculated by

θ1=tan⁻¹((H/2+S)/L)

θ2=tan⁻¹(\sqrt{(W/2)²+(H+S)²}/L)

θ3=tan⁻¹(S/L) (1)

θ5=tan⁻¹(\sqrt{(W/2)²+(H/2)²}/L) (2)

Table 1 shows a relationship between the diagonal dimension X of the rear projection screen 111, the aspect ratio A thereof, the horizontal dimension W, the vertical dimension H, the distance S from the projection optical axis of the projection optical system 112 to the lower edge of the rear projection screen 111, the distance L from the position spaced the distance S apart from the lower edge of the rear projection screen 111 to the pupil of the projection optical system 112, the angle of incidence θ1 onto the center of the rear projection screen 111, and the maximum and minimum angles of incidence θ2 and θ3 onto the rear projection screen 111, for example, when the angled projection type shown in FIG. 9 is used for the projection display apparatus 110 including the rear projection screen 111 which is 60 inches in diagonal dimension.

TABLE 1
Diagonal Dimension X (60 inches)

| | | | | | Angle of | Maximum | Minimum |
|---|---|---|---|---|---|---|---|
| Aspect | Horizontal | Vertical | | | Incidence | Angle of | Angle of |
| Ratio | Dimension | Dimension | Distance | Distance | θ1 on | Incidence | Incidence |
| A | W | H | S | L | Center | θ2 | θ3 |
| 4:3 | 1218 mm | 914 mm | 180 mm | 500 mm | 51.8° | 68.2° | 19.8° |
| 16:9 | 1328 mm | 747 mm | 180 mm | 500 mm | 47.9° | 66.3° | 19.8° |

Table 2 shows a relationship between the diagonal dimension X of the rear projection screen 111, the aspect ratio A thereof, the horizontal dimension W, the vertical dimension H, the distance L from the center of the rear projection screen 111 to the pupil of the projection optical system 112, the angle of incidence θ4 onto the center of the rear projection screen 111, and the maximum angle of incidence θ5 onto the rear projection screen 111, for example, when the central projection type is used for the projection display apparatus 110 including the rear projection screen 111 which is 60 inches in diagonal dimension. In the case of the central projection type, it is also apparent from FIG. 8 that the angle of incidence θ4 on the center is the minimum angle of incidence and is equal to 0 degrees. It is necessary that the central projection type is longer in distance L from the center of the rear projection screen 111 to the pupil of the projection optical system 112 than the angled projection type to prevent the projection optical system 112 from cutting off the projected light beam 115.

TABLE 2
Diagonal Dimension X (60 inches)

| | | | | Angle of | Maximum |
|---|---|---|---|---|---|
| Aspect | Horizontal | Vertical | | Incidence | Angle of |
| Ratio | Dimension | Dimension | Distance | θ4 on | Incidence |
| A | W | H | L | Center | θ5 |
| 4:3 | 1218 mm | 914 mm | 700 mm | 0° | 47.4° |
| 16:9 | 1328 mm | 747 mm | 700 mm | 0° | 47.4° |

A comparison between Tables 1 and 2 also shows that the use of the angled projection type for achievement of the reduction in thickness of the projection display apparatus 110 results in a construction such that the angle of incidence upon the center of the rear projection screen 111 is a large angle, e.g. 47.9 degrees, rather than 0 degrees, and such that the maximum angle of incidence θ2 is larger than the maximum angle of incidence θ5 obtained by the central projection type.

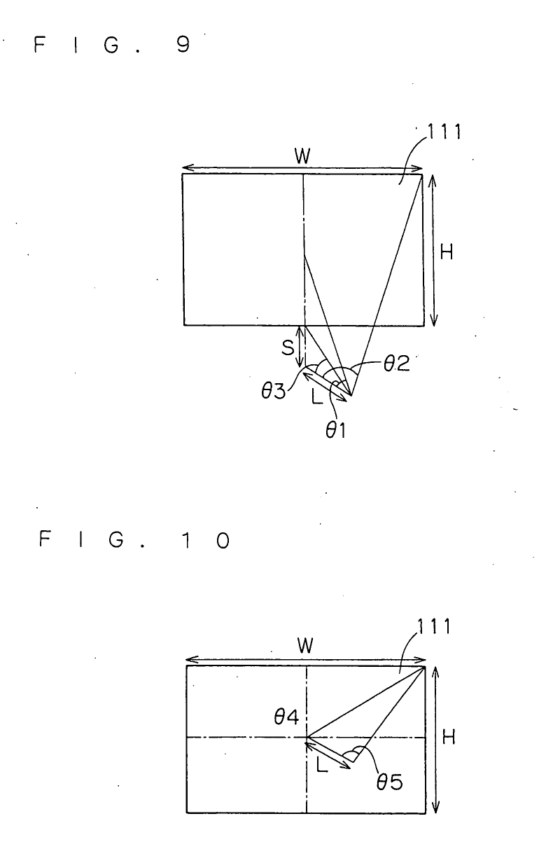

The influence of the expansion of a central portion of the Fresnel lens sheet 20 toward the viewer side under the influence of temperature and humidity will be described with reference to FIG. 11. When the Fresnel lens sheet 20 is held flat inherently, the projected light beam 115 impinges on a position 115A of the Fresnel lens sheet 20, as shown in FIG. 11. However, when the Fresnel lens sheet 20 with the peripheral portion fixedly held is influenced by temperature and humidity, the central portion of the Fresnel lens sheet is expanded as indicated by 20A in FIG. 11 toward the viewer or incident side. In this case, the occurrence of the maximum amount of warpage L2 in the central portion of the sheet 20A causes the amount of deviation L3 of the point of impingement of the light beam 115. Table 3 below shows a relationship between the angle of incidence θ of the light beam 115 on the sheet 20 and the amount of deviation L3 of the point of impingement at each point spaced a distance L1 apart from the central portion of the Fresnel lens sheet 20 in which warp deformation appears. The relationship of values shown in Table 3 is that obtained when the angled projection type is employed and the amount of warpage L2 in the central portion of the Fresnel lens sheet 20 is 3 mm. In Table 3, a position in which the distance L1 from the central portion is 0 corresponds to the central portion of the Fresnel lens sheet 20, and a position in which the distance L1 from the central portion is 457 mm corresponds to the peripheral portion of the Fresnel lens sheet 20.

TABLE 3

| Distance | Amount of | Angle of | Amount of |
|---|---|---|---|
| L1 | Warpage L2 | Incidence θ | Deviation L3 |
| 0 | 3.00 mm | 51.8° | 3.81 mm |
| 100 mm | 2.86 mm | 55.8° | 4.20 mm |
| 200 mm | 2.43 mm | 59.1° | 4.05 mm |
| 300 mm | 1.71 mm | 61.9° | 3.19 mm |
| 400 mm | 0.70 mm | 64.2° | 1.45 mm |
| 457 mm | 0 | 65.4° | 0 |

It will be found also from Table 3 that the use of the angled projection type for achievement of the reduction in thickness as in the projection display apparatus 10 of the first preferred embodiment causes the large angle of incidence θ of the light beam 115 on the rear projection screen 111, resulting in the large value, rather than zero, of the angle of incidence θ1 on the center of the rear projection screen 111. Thus, if 3 mm warpage occurs in the central portion of the Fresnel lens sheet 20 under the influence of temperature and humidity, the point of impingement of the projected light beam 115 on the Fresnel lens sheet 20 deviates by 3.81 mm in the central portion of the rear projection screen 111, and the maximum deviation L3 is greater than 4 mm. This results in significant image degradation.

Further, if the warpage of the Fresnel lens sheet 20 and the like under the influence of temperature and humidity causes variations in the amount of clearance 40 between the Fresnel lens sheet 20 and the horizontal lenticular lens plate 10, the image degradation known as blurring might result.

Although the warpage of the Fresnel lens sheet 20 in the projection display apparatus of the angled projection type is mainly discussed in the first preferred embodiment, image degradation similarly occurs in the projection display apparatus of the central projection type if the Fresnel lens sheet 20 is warped under the influence of temperature and humidity. However, the central projection type exhibits a smaller amount of warpage than the angled projection type, and is accordingly smaller in the amount of image degradation. In the central projection type, the image degradation due to the variations in the amount of clearance 40 between the Fresnel lens sheet 20 and the horizontal lenticular lens plate 10 similarly occurs although the amount of degradation is small.

Drawbacks of the increased thickness of the Fresnel lens sheet 20 will be described with reference to FIG. 12. As indicated in FIG. 12, the thickness of the Fresnel lens sheet 20 is designated by m. A stray light component 300 passing through a refraction Fresnel lens portion 23 of the Fresnel lens 22 and a stray light component 310 passing through a total reflection Fresnel lens portion 24 thereof are not substantially collimated by the Fresnel lens 22, but are totally reflected from the exit surface of the Fresnel lens sheet 20. Thereafter, the stray light components 300 and 310 are reflected from the Fresnel lens 22, pass through the exit surface of the Fresnel lens sheet 20, and exit from the Fresnel lens sheet 20 to the viewer side at a position spaced a distance M from the real image (the correct light beam 115). The stray light components 300 and 310 are those known as a ghost image which is a significant factor contributing to the image degradation.

It will be found also from FIG. 12 that the distance M between the real image and the ghost image is roughly proportional to the thickness m of the Fresnel lens sheet 20. The increase in thickness m of the Fresnel lens sheet 20 increases the distance M to result in clear recognition of the ghost image components. Therefore, the smaller the thickness m of the Fresnel lens sheet 20 is, the smaller the distance M is and the more visually inconspicuous the ghost image components are, which provides a preferable image.

To this end, the first preferred embodiment employs the front plate 11 constructed by the glass substrate, the metal frame members 30 and the like to constitute the rear projection screen 111 as discussed above, thereby achieving the reduction in thickness of the Fresnel lens sheet 20 and suppressing the warpage deformation of the Fresnel lens sheet 20 under the influence of temperature and humidity.

Specifically, the horizontal lenticular lens sheet 12 and the front plate 11 made of glass which is a highly rigid material are bonded together to form the highly rigid horizontal lenticular lens plate 10, to which the Fresnel lens sheet 20 is fixed using the metal frame members 30. This reduces the thickness of the Fresnel lens sheet 20 without the lowering of the rigidity (strength) of the rear projection screen 111 to reduce the influence of the stray light resulting from undesired reflection in the Fresnel lens sheet 20, thereby achieving improvements in image quality.

The glass which forms the front plate 11 has not only the high rigidity but also a very low coefficient of linear expansion, thereby to constitute the rear projection screen 111 strong enough not to be deformed under the influence of temperature and humidity. In this regard, the glass substrate has a coefficient of linear expansion of 9×10⁻⁶/K whereas a resin substrate made of, for example, polyester has a coefficient of linear expansion of 55×10⁻⁶ to 100×10⁻⁶/K. It will be apparent that the glass substrate is by far superior to the resin substrate in characteristics resistant to temperature and humidity. A modification may be made such that the front plate 11 is made of a highly rigid resin having a low coefficient of linear expansion and a high rigidity. In this case, the front plate 11 is easy to process (e.g., mold) because the front plate 11 is made of resin.

The Fresnel lens sheet 20 is fixed under a predetermined tension to the horizontal lenticular lens plate 10 by using the metal frame members 30. The tension absorbs the expansion of the Fresnel lens sheet 20 resulting from the influence of temperature and humidity to prevent the Fresnel lens sheet 20 from being warped by the influence of temperature and humidity.

The use of the metal frame members 30 as a securing fixture easily increases the rigidity of the metal frame members 30 to firmly fix the horizontal lenticular lens plate 10 and the Fresnel lens sheet 20 together. A modification may be made such that a securing fixture (a frame member made of resin or the like) made of a highly rigid resin having a high rigidity is used in place of the metal frame members 30 to fix the horizontal lenticular lens plate 10 and the Fresnel lens sheet 20 together. In this case, the securing fixture is easy to mold because the securing fixture is made of resin.

The material of the metal frame members 30 and the material of the resin substrate 21 of the Fresnel lens sheet 20 have coefficients of linear expansion close to each other (as an example, the metal frame members 30 are made of aluminum and the resin substrate 21 is made of polyethylene terephthalate (PET) in the first preferred embodiment). Thus, if the metal frame members 30 and the Fresnel lens sheet 20 expand under the influence of temperature and humidity, the metal frame members 30 and the Fresnel lens sheet 20 are substantially equal in the amount of deformation. This prevents the warpage or the like of the Fresnel lens sheet 20. Although the metal frame members 30 are made of aluminum and the resin substrate 21 is made of polyethylene terephthalate (PET) as an example in the first preferred embodiment, the materials of the metal frame members 30 and the resin substrate 21 are not limited to those materials.

In the first preferred embodiment, the Fresnel lens 22 of the Fresnel lens sheet 20 includes the plurality of refraction and total reflection structures 25 each including the refraction Fresnel lens portion 23 and the total reflection Fresnel lens portion 24. A combination of the refraction Fresnel lens portion 23 and the total reflection Fresnel lens portion 24 can efficiently convert the projected light beam 115 to substantially collimated light. A modification may be made such that either the refraction Fresnel lens portions 23 or the total reflection Fresnel lens portions 24 constitute the Fresnel lens 22, as described above.

The light diffusing material is mixed in the adhesive 15 (or the bonding layer) for bonding the horizontal lenticular lens sheet 12 and the front plate 11 together. The mixed light diffusing material effectively diffuses the projected light beam 115 in all directions, thereby to increase the viewing angle of the screen 111 not only horizontally but also vertically without the need to use a vertical lenticular lens. A modification may be made such that the light diffusing material is mixed in the horizontal lenticular lens sheet 12 or in the Fresnel lens sheet 20, as described above.

The plurality of black light-blocking layers 16 in the form of stripes extending in the direction in which the lens portions 14a of the horizontal lenticular lens 14 extend are provided on the flat surface of the horizontal lenticular lens sheet 12 so as to be in corresponding relation to the lens portions 14a, as shown in FIG. 3. The black light-blocking layers 16 can effectively block incident light passing through the horizontal lenticular lens sheet 12 except the projected light beam 115 correctly collected by the lens portions 14a, to achieve improvements in display image contrast and the like.

At least one surface of the horizontal lenticular lens plate 10 is subjected to at least one of the hard coating process, the antistatic process, and the anti-reflection process. This suppresses the influences of flaws, static electricity, undesired surface reflection or the like.

At least one surface of the Fresnel lens sheet 20 is subjected to the anti-reflection process. This suppresses the influences of undesired surface reflection or the like.

The first preferred embodiment may be modified so that a vertical lenticular lens having the function of refracting the incident light in a vertical direction is formed on the surface of the Fresnel lens sheet 20 which faces the viewer side. This increases the viewing angle in the vertical direction.

### Second Preferred Embodiment

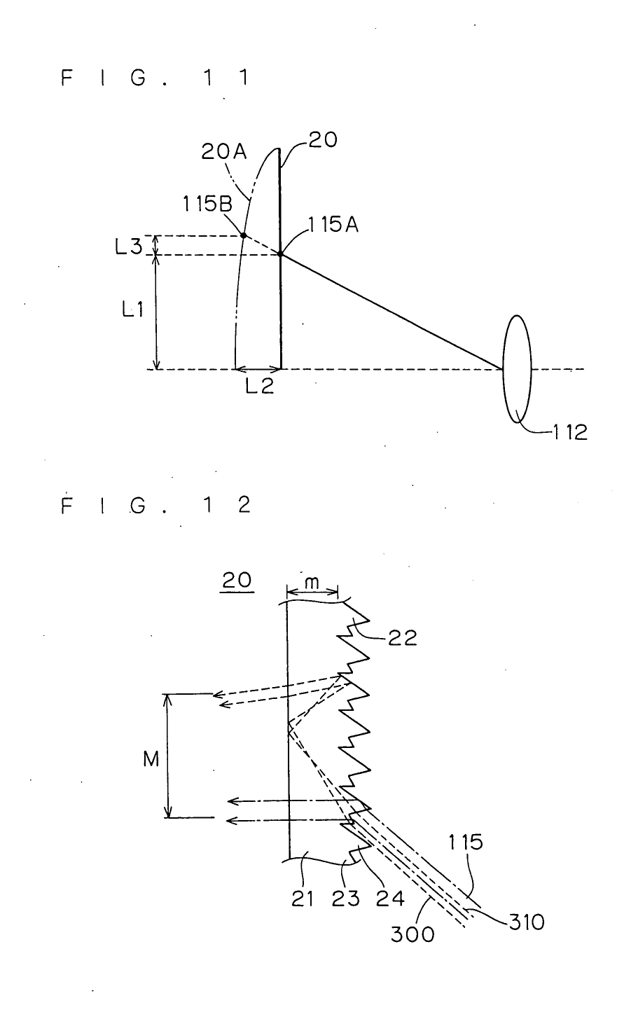

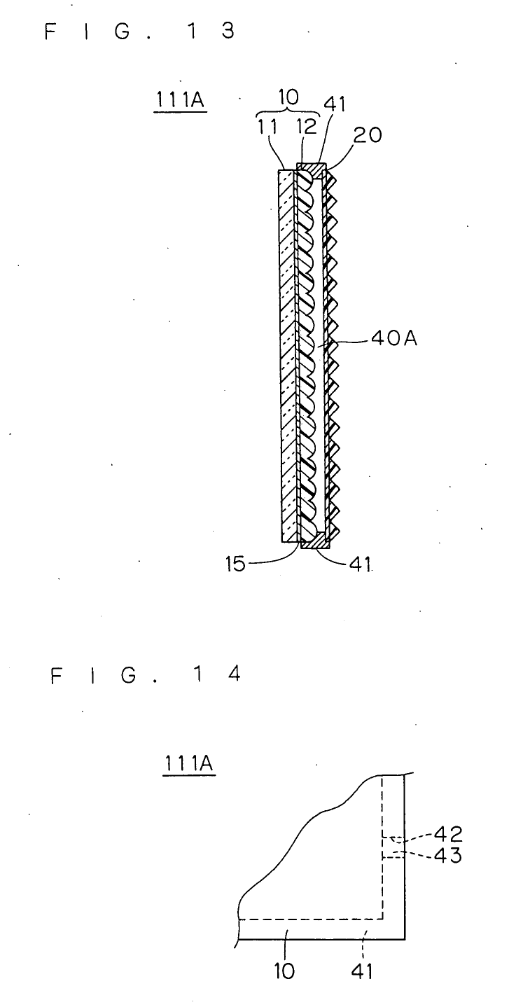

FIG. 13 is a horizontal sectional view of a rear projection screen according to a second preferred embodiment of the present invention. FIG. 14 is a front view of principal parts of the rear projection screen of FIG. 13. The rear projection screen 111A according to the second preferred embodiment substantially differs from the rear projection screen 111 according to the first preferred embodiment only in the structure for fixing the horizontal lenticular lens plate 10 and the Fresnel lens sheet 20 together and in being capable of adjusting the air pressure in a clearance space 40A between the horizontal lenticular lens plate 10 and the Fresnel lens sheet 20. Parts in the second preferred embodiment corresponding to those in the first preferred embodiment are designated by the same reference numerals and characters and will not be described.

In the rear projection screen 111A according to the second preferred embodiment, the clearance space 40A between the horizontal lenticular lens plate 10 and the Fresnel lens sheet 20 is hermetically sealed by a sealing member 41 against the external environment, as illustrated in FIG. 13. The sealing member 41 is provided throughout the periphery of the rear projection screen 111A so as to seal the peripheral portion of the clearance space 40A between the horizontal lenticular lens plate 10 and the Fresnel lens sheet 20. Because the sealing member 41 also fixes the horizontal lenticular lens plate 10 and the Fresnel lens sheet 20 together, the above-mentioned metal frame members 30 are dispensed with according to the second preferred embodiment. However, the metal frame members 30 may be used in addition to the sealing member 41.

Various materials including resin, rubber and the like may be used as the material of the sealing member 41. An adhesive, a self-adhesive tape and the like may be used as a means for fixing the sealing member 41 to the horizontal lenticular lens plate 10 and the Fresnel lens sheet 20. Alternatively, a sealing material which solidifies after being injected between the horizontal lenticular lens plate 10 and the Fresnel lens sheet 20 may be used as the sealing member 41.

A communication port 42 capable of communication between the inside and outside for adjusting the air pressure in the clearance space 40A is provided on at least one location of the peripheral portion of the rear projection screen 111A, as illustrated in FIG. 14. The communication port 42 is closed, for example, by inserting a closing member (opening/closing part) 43 into the communication port 42. The closed communication port 42 is opened, for example, by removing the closing member 43. Thus, the communication port 42 is opened and closed by attaching and removing the closing member 43, and the air pressure in the clearance space 40A is adjustable through the open communication port 42.

According to the second preferred embodiment, with the clearance space 40A exposed to a reduced-pressure atmosphere lower in pressure than: the external environment (atmospheric pressure) through the communication port 42, the communication port 42 is closed to hold the pressure in the clearance space 40A lower than the atmospheric pressure. During the assembly of the rear projection screen 111A, a pressure difference between the inside of the clearance space 40A and the external environment acts to force the Fresnel lens sheet 20 toward the horizontal lenticular lens plate 10, thereby holding the flatness of the Fresnel lens sheet 20 without the need to positively tension the Fresnel lens sheet 20 which has been performed in the first preferred embodiment. The Fresnel lens sheet 20 is fixed (or bonded) to the horizontal lenticular lens plate 10 while holding the pressure in the clearance space 40A lower than the atmospheric pressure. This facilitate the fixing while holding the flatness of the Fresnel lens sheet 20 without the need to positively tension the Fresnel lens sheet 20.

Appropriately opening the communication port 42 to adjust the pressure in the clearance space 40A through the opened communication port 42 facilitates the adjustment of a distance between the Fresnel lens sheet 20 and the horizontal lenticular lens plate 10.

As described hereinabove, the second preferred embodiment produces effects substantially similar to those produced by the first preferred embodiment, and is also capable of holding the flatness of the Fresnel lens sheet 20 without the need to positively tension the Fresnel lens sheet 20 which has been performed in the first preferred embodiment, because the clearance space 40A between the horizontal lenticular lens plate 10 and the Fresnel lens sheet 20 is hermetically sealed against the external environment and is maintained at a lower pressure than the atmospheric pressure. Additionally, the Fresnel lens sheet 20 is fixed (or bonded) to the horizontal lenticular lens plate 10 while the pressure in the clearance space 40A is held lower than the atmospheric pressure. This facilitate the fixing while holding the flatness of the Fresnel lens sheet 20 without the need to positively tension the Fresnel lens sheet 20.

Adjusting the pressure in the clearance space 40A by opening and closing the communication port 42 facilitates the adjustment of the distance between the Fresnel lens sheet 20 and the horizontal lenticular lens plate 10, thereby to facilitate the adjustment of the setting of the rear projection screen 111A, and the like.

### Third Preferred Embodiment

FIG. 15 is an exploded perspective view of a rear projection screen according to a third preferred embodiment of the present invention. As shown in FIG. 15, the rear projection screen 111B according to the third preferred embodiment includes: a Fresnel lens sheet 51; a horizontal lenticular lens plate 52; a frame 53; lower, left-hand and right-hand elastic members 54 to 56; and upper, lower, left-hand and right-hand retaining members 57 to 60. The rear projection screen 111B is incorporated into the above-mentioned projection display apparatus 110 of FIG. 7 and the like in a substantially similar manner to the rear projection screen 111 of the first preferred embodiment.

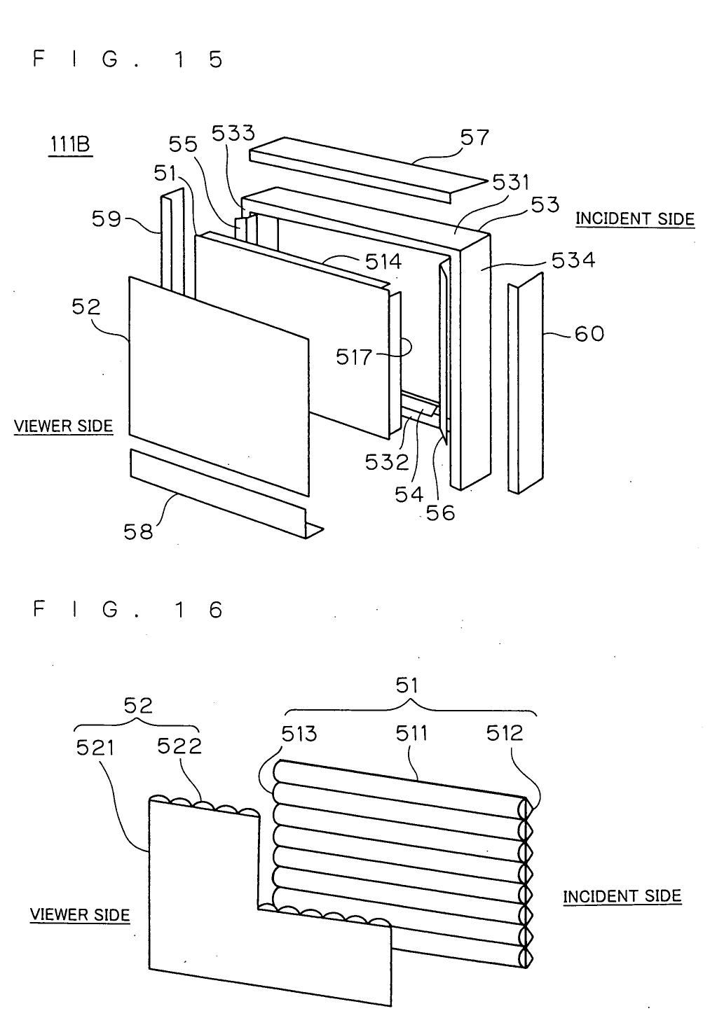

The Fresnel lens sheet 51 includes a resin substrate 511 in rectangular sheet form, a Fresnel lens 512 formed on one surface of the resin substrate 511, and a vertical lenticular lens 513 formed on the other surface of the resin substrate 511, as schematically shown in FIGS. 16 and 17. The Fresnel lens sheet 51 is made of a resin. The Fresnel lens 512 converts the projected light beam 115 incident thereon into substantially collimated light. The vertical lenticular lens 513 vertically refracts the projected light beam 115 incident thereon.

More specifically, the resin substrate 511 is in the form of a thin sheet having a thickness of, e.g., 0.25 mm and is made of polyethylene terephthalate (PET). The Fresnel lens 512 includes a plurality of lens elements concentric about the center of a lower portion of the screen and having a sawtooth sectional configuration, as illustrated in FIGS. 16 and 17. The Fresnel lens 512 has, for example, a maximum thickness of 0.25 mm and is made of an ultraviolet (UV) curable acrylic resin. The vertical lenticular lens 513 includes a plurality of lens elements each extending horizontally and having a substantially convex sectional configuration, as illustrated in FIGS. 16 and 17. The vertical lenticular lens 513 has, for example, a maximum thickness of 0.125 mm and is made of a UV curable acrylic resin.

Catch portions 514 to 517 for mounting to the frame 53 are provided on the four sides, i.e. upper, lower, left-hand and right-hand sides respectively, of the Fresnel lens sheet 51. The catch portions 514 to 517 are formed by bending the edges on the four sides, i.e. upper, lower, left-hand and right-hand sides, of the Fresnel lens sheet 51 toward the incident side (from which the projected light beam 115 is incident on the screen 111B).

The Fresnel lens sheet 51 is held by the frame 53, with a surface of the Fresnel lens sheet 51 on the Fresnel lens 512 side facing toward the incident side.

To prepare the Fresnel lens sheet 51, for example, the following procedure is carried out. First, a UV curable acrylic resin is applied to one surface of the previously formed resin substrate 511. Next, UV irradiation is performed while performing a rolling process for pressure-rotating a roller die formed in a pattern of a substantially concave lens configuration over the UV curable acrylic resin to cure the UV curable acrylic resin, thereby forming the vertical lenticular lens 513. Subsequently, a UV curable acrylic resin is applied to a die formed in a pattern of a substantially sawtooth lens configuration, and the other surface of the resin substrate 511 is brought into contact with the UV curable acrylic resin. UV irradiation is performed while pressurizing the UV curable acrylic resin to cure the UV curable acrylic resin, thereby forming the Fresnel lens 512. Finally, a bending process is carried out to bend the edges on the four sides, i.e. upper, lower, left-hand and right-hand sides, of the Fresnel lens sheet 51 toward the incident side, thereby forming the catch portions 514 to 517.

The horizontal lenticular lens plate 52 includes a glass substrate 521 in the form of a rectangular plate, and a horizontal lenticular lens 522 formed on one surface of the glass substrate 521, as schematically illustrated in FIGS. 16 and 17. The horizontal lenticular lens 522 horizontally refracts the projected light beam 115 incident thereon.

The glass substrate 521 has a thickness of, for example, 3 mm and is made of plate glass. The horizontal lenticular lens 522 has a plurality of lens elements each extending vertically and having a substantially convex sectional configuration, as illustrated in FIGS. 16 and 17. The horizontal lenticular lens 522 has, for example, a maximum thickness of 0.125 mm and is made of a UV curable acrylic resin.

The horizontal lenticular lens plate 52 is held by the frame 53, with a surface of the horizontal lenticular lens plate 52 on the horizontal lenticular lens 522 side facing toward the incident side. When mounted, the horizontal lenticular lens plate 52 is opposed to the Fresnel lens sheet 51 and located on the viewer side of the Fresnel lens sheet 51.

To prepare the horizontal lenticular lens plate 52, for example, the following procedure is carried out. First, a UV curable acrylic resin is applied to one surface of a resin sheet substrate (not shown). Next, UV irradiation is performed while performing a rolling process for pressure-rotating a roller die formed in a pattern of a substantially concave lens configuration over the UV curable acrylic resin to cure the UV curable acrylic resin, thereby forming the horizontal lenticular lens 522. Subsequently, the horizontal lenticular lens 522 is bonded to the glass substrate 521, whereby the horizontal lenticular lens plate 52 is formed.

The frame 53 is provided to hold the Fresnel lens sheet 51 and the horizontal lenticular lens plate 52. The frame 53 has a substantially rectangular hollow configuration, and is made of metal which is a highly rigid material, for example, an aluminum alloy (or aluminum). The frame 53 has upper, lower, left-hand and right-hand frame portions 531 to 534 which hold the four sides, i.e. upper, lower, left-hand and right-hand sides respectively, of the Fresnel lens sheet 51 and the horizontal lenticular lens plate 52.

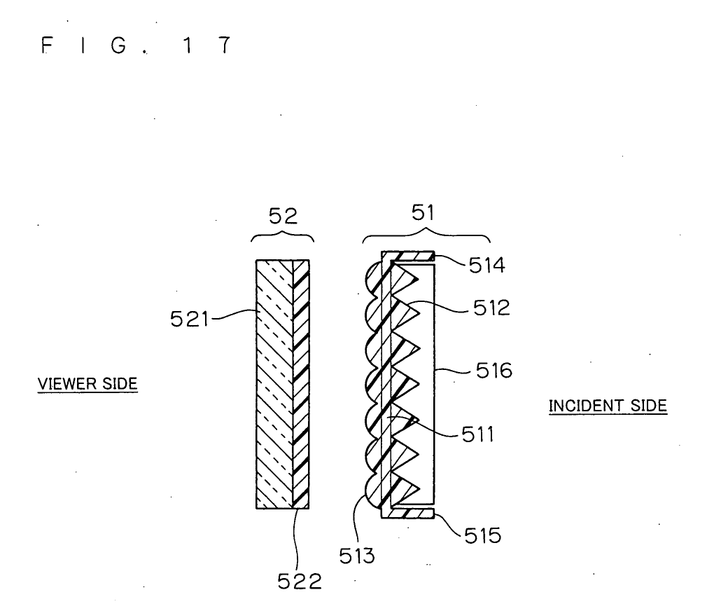

As shown in FIG. 18, the upper frame portion 531 of the frame 53 is provided with a hook portion 535 protruding toward the viewer side. The hook portion 535 extends along the upper side of the Fresnel lens sheet 51. The catch portion 514 on the upper side of the Fresnel lens sheet 51 is hooked and held on the hook portion 535. The edge portion on the upper side of the Fresnel lens sheet 51 constituting the catch portion 514 is bent at such an angle as to be substantially parallel to an engagement surface 535a on a viewer-side edge of the hook portion 535.

As illustrated in FIGS. 18 and 19, the retaining member 57 holds the upper side of the horizontal lenticular lens plate 52 against the frame 53. A catch portion 571 for engaging and holding the upper side of the horizontal lenticular lens plate 52 is provided on a viewer-side edge of the retaining member 57. As illustrated in FIG. 19, the retaining member 57 extends along the upper side of the horizontal lenticular lens plate 52, and has a length L57 which is slightly less than the horizontal dimension L52 of the horizontal lenticular lens plate 52. The length of the upper frame portion 531 is slightly longer than the horizontal dimension L52 of the horizontal lenticular lens plate 52. The horizontal dimension of the hook portion 535 approximately corresponds to the length of the upper side of the Fresnel lens sheet 51. Thus, the upper catch portion 514 of the Fresnel lens sheet 51 is held so that the entire length of the inner periphery thereof is always in contact with the engagement surface 535a of the hook portion 535. A plurality of screws 61 are used to fix the retaining member 57 to the frame portion 531.

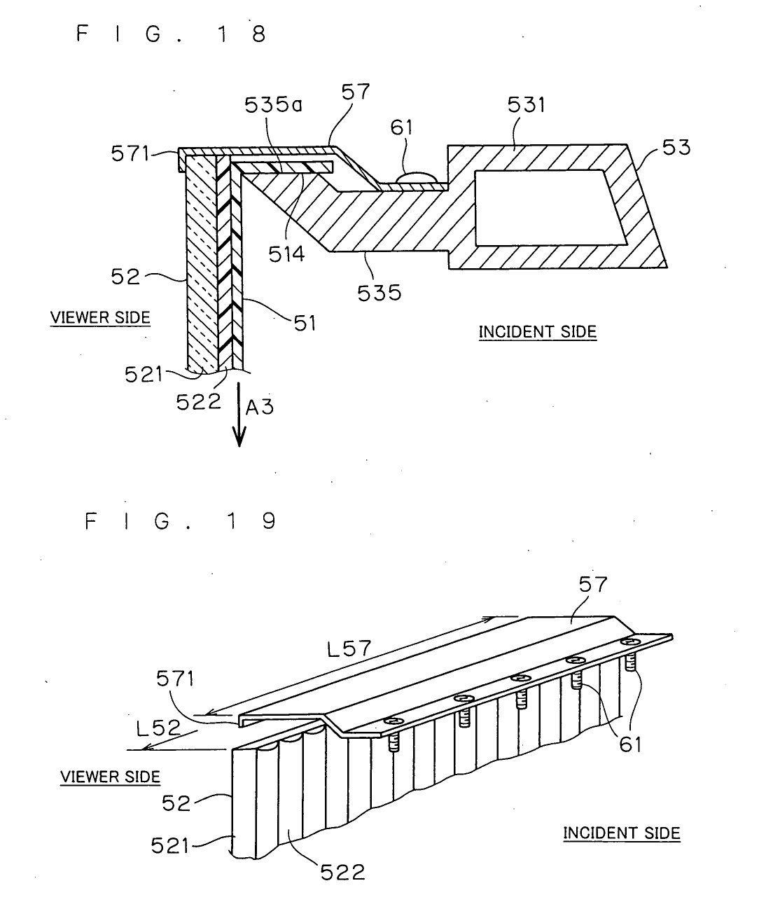

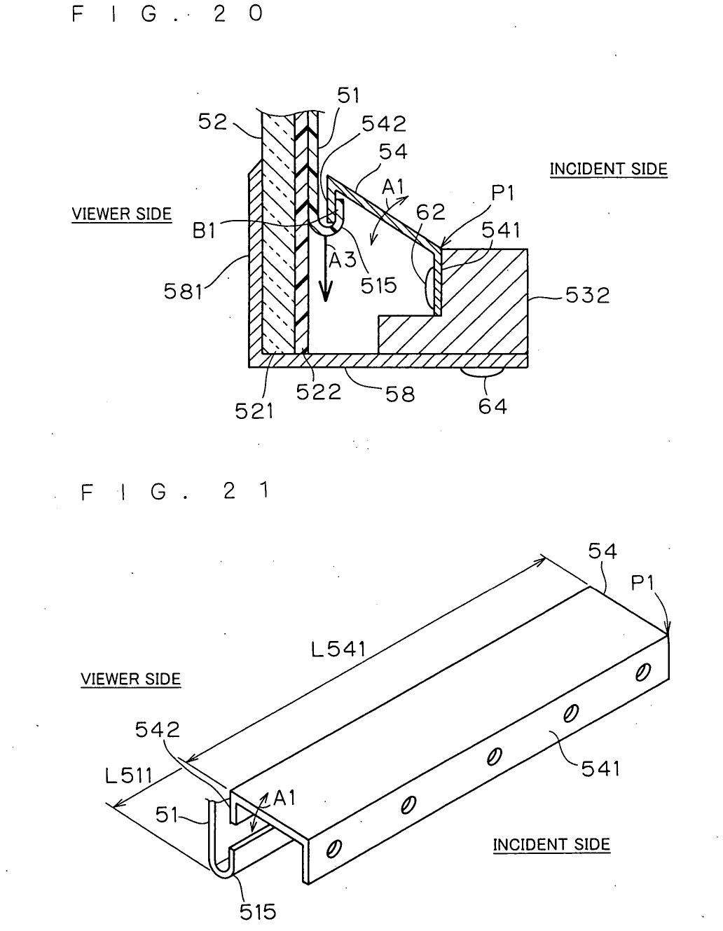

With reference to FIGS. 20 and 21, the elastic member 54 is mounted to the lower frame portion 532 of the frame 53, and the frame 53 holds the lower side of the Fresnel lens sheet 51 by the use of the elastic member 54. The elastic member 54 has resilience, and is a plate-like member extending in one direction. A plurality of screws 62 are used to fix the elastic member 54 to a side surface of the frame portion 532 which faces toward the viewer side. The elastic member 54 is bent at a bend P1 of a fixed portion 541 thereof fixed by the screws 62 into a substantially dog-legged shape toward the viewer side, and includes a locking portion 542 formed by downwardly bending the viewer-side edge portion of the elastic member 54. Thus, the elastic member 54 is elastically deformed, with the bend PI as a fulcrum, in directions indicated by the arrow A1 of FIG. 20 so that the bending angle varies.

The lower edge portion of the Fresnel lens sheet 51 is accordingly bent into a substantially U-shaped configuration at a bending angle of approximately 180 degrees toward the incident side, whereby a catch portion 515 is formed. When engaged, the edge portion of the catch portion 515 is approximately parallel to the locking portion 542 of the elastic member 54. As shown in FIG. 21, the entire length L541 of the elastic member 54 is slightly less than the length L51 of the lower side of the Fresnel lens sheet 51. Thus, the catch portion 515 of the Fresnel lens sheet 51 is held so that the entire length of the inner periphery thereof is always in contact with the locking portion 542 of the elastic member 54.

The retaining member 58 for holding the horizontal lenticular lens plate 52 is fixed to the lower frame portion 532 by a plurality of screws 64. The retaining member 58 has a substantially L-shaped sectional configuration, and extends along the lower side of the horizontal lenticular lens plate 52. The retaining member 58 has a catch portion 581 on the viewer-side edge thereof for engagement with the lower side of the horizontal lenticular lens plate 52. The catch portion 581 of the retaining member 58 holds the lower side of the horizontal lenticular lens plate 52 against the frame 53.

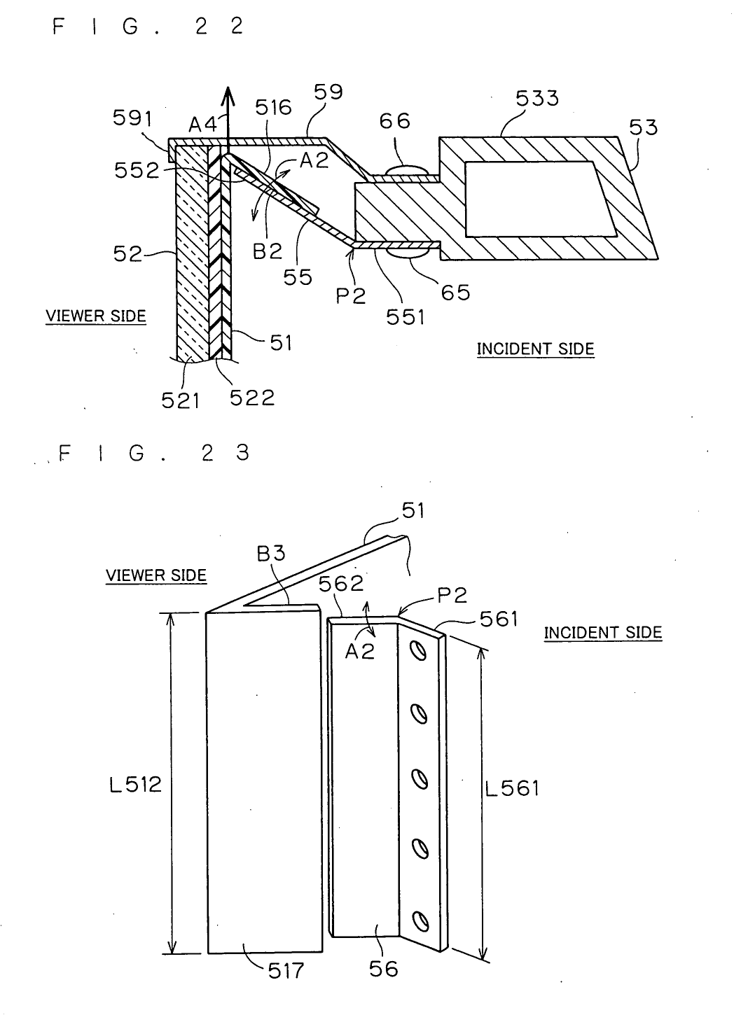

With reference to FIGS. 22 and 23, the elastic members 55 and 56 are mounted to the left-hand and right-hand frame portions 533 and 534 of the frame 53, and the frame 53 holds the left-hand and right-hand sides of the Fresnel lens sheet 51 by the use of the elastic members 55 and 56. The elastic members 55 and 56 have resilience, and are plate-like members extending in one direction. A plurality of screws 65 are used to fix the elastic member 55 and 56 to respective inner side surfaces of the frame portions 533 and 534. The elastic members 55 and 56 are bent obliquely outwardly at bends P2 of fixed portions 551 and 561 thereof fixed by the screws 65 into a substantially dog-legged shape. Thus, the elastic members 55 and 56 are elastically deformed, with the bends P2 as a fulcrum, in directions indicated by the arrow A2 of FIGS. 22 and 23 so that the bending angle varies. The elastic members 55 and 56 further include locking portions 552 and 562 on the viewer-side edges thereof for engagement with left-hand and right-hand catch portions 516 and 517, respectively, of the Fresnel lens sheet 51.

The left-hand and right-hand edge portions of the Fresnel lens sheet 51 are accordingly bent obliquely inwardly toward the incident side, whereby the catch portions 516 and 517 are formed. The bending angle of the catch portions 516 and 517 are set so that the edge portions of the catch portions 516 and 517, when engaged, are approximately parallel to the locking portions 552 and 562 of the elastic members 55 and 56. As shown in FIG. 23, the entire length L561 of the elastic members 55 and 56 is slightly less than the length L512 of the left-hand and right-hand sides of the Fresnel lens sheet 51. Thus, the left-hand and right-hand catch portions 516 and 517 of the Fresnel lens sheet 51 are held so that the entire lengths of the inner peripheries thereof are always in contact with the locking portions 552 and 562 of the elastic members 55 and 56.

The retaining members 59 and 60 for holding the horizontal lenticular lens plate 52 are fixed to the left-hand and right-hand frame portions 533 and 534, respectively, by a plurality of screws 66. The retaining member 59 is a substantially plate-like member extending along the left-hand side of the horizontal lenticular lens plate 52. The retaining member 59 has a catch portion 591 on the viewer-side edge thereof for engagement with the left-hand side of the horizontal lenticular lens plate 52. The retaining member 60 is similar in configuration to the retaining member 59, and has a catch portion not shown. The catch portion 591 of the retaining member 59 holds the left-hand side of the horizontal lenticular lens plate 52 against the frame 53, and the catch portion not shown of the retaining member 60 holds the right-hand side of the horizontal lenticular lens plate 52 against the frame 53.

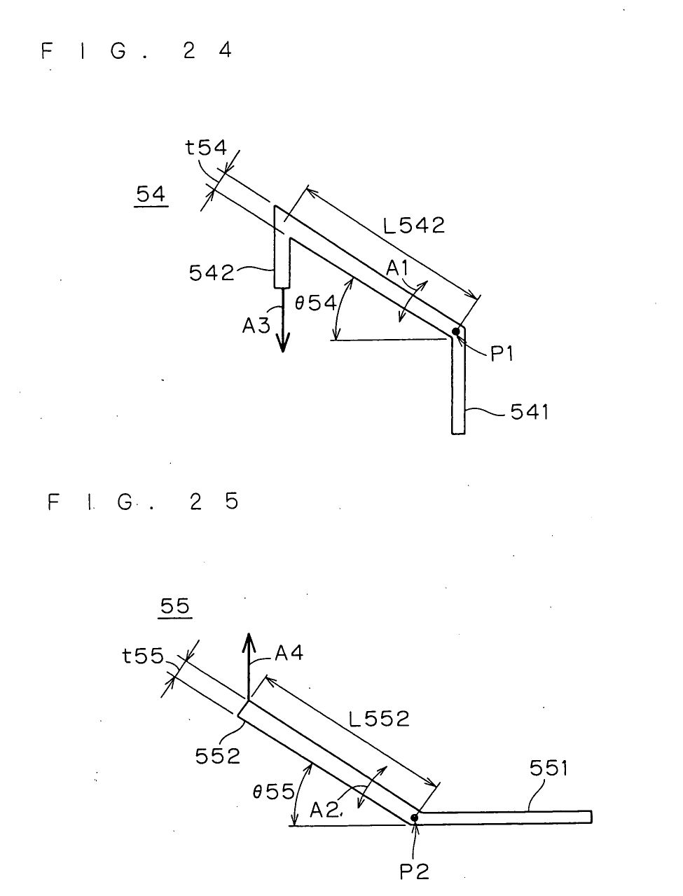

Next, the specific construction of the elastic members 54 to 56 will be described with reference to FIGS. 24 and 25. Although, of the left-hand and right-hand elastic members 55 and 56, only the left-hand elastic member 55 will be described, the right-hand elastic member 56 is substantially similar in construction to the left-hand elastic member 55.

As shown in FIG. 24, the lower elastic member 54 has a thickness t54 of 0.2 mm and is made of beryllium copper. The elastic member 54 has a spring length L542 of 15.5 mm with the bend P1 as a fulcrum, and is fixed in cantilevered fashion to the lower frame portion 532, with an initial deflection angle θ54 of 15 degrees with respect to the horizontal, to generate a spring force proportional to variations in deflection angle θ54. The spring force is generated uniformly along the entire length L541 of the elastic member 54 shown in FIG. 21. Thus, uniform tension is applied to the lower side of the Fresnel lens sheet 51 along the entire length L511 of 1200 mm. The locking portion 542 applies tension the magnitude of which is substantially proportional to the amount of deflection (the variations in deflection angle θ54) to the Fresnel lens sheet 51.

The Fresnel lens sheet 51 is mounted in such a manner that the catch portion 515 on the lower side of the Fresnel lens sheet 51 is brought into engagement with the locking portion 542, with the elastic member 54 deflected upwardly of FIG. 20. Thus, downwardly pulling tension as indicated by the arrow A3 is applied to the Fresnel lens sheet 51. The elastic member 54 is designed to generate a maximum spring force of 45.5 kgf so as to remove the maximum warpage of the Fresnel lens sheet 51 at a minimum storage temperature (−20° C.) in warehouse.

As shown in FIG. 25, the left-hand elastic member 55 has a thickness t55 of 0.2 mm and is made of beryllium copper. The elastic member 55 has a spring length L552 of 15.5 mm with the bend P2 as a fulcrum, and is fixed in cantilevered fashion to the left-hand frame portion 533, with an initial deflection angle θ55 of 42 degrees with respect to the horizontal directed toward the front of the viewer, to generate a spring force proportional to variations in deflection angle θ55. The spring force is generated uniformly along the entire length L561 of the elastic member 56 shown in FIG. 23. Thus, the left-hand and right-hand elastic members 55 and 56 apply uniform tension to the Fresnel lens sheet 51 along the entire length L512 of 900 mm of the left-hand and right-hand sides. The locking portions 552 and 562 of the elastic members 55 and 56 apply tension the magnitude of which is substantially proportional to the amount of deflection (the variations in deflection angle θ55) to the Fresnel lens sheet 51.

The Fresnel lens sheet 51 is mounted in such a manner that the left-hand and right-hand catch portions 516 and 517 of the Fresnel lens sheet 51 are brought into engagement with the locking portions 552 and 562 respectively, with the elastic members 55 and 56 deflected horizontally inwardly. Thus, horizontally outwardly pulling tension as indicated by the arrow A4 is applied to the Fresnel lens sheet 51. The left-hand and right-hand elastic members 55 and 56 are designed to generate a maximum spring force of 60 kgf so as to remove the maximum warpage of the Fresnel lens sheet 51 at a minimum storage temperature (−20° C.) in warehouse.

The elastic members 54, 55 and 56 are of substantially the same sectional configuration along substantially the entire length of the lower, left-hand and right-hand sides of the Fresnel lens sheet 51, thereby to generate the uniform spring force along the entire length.

The horizontal lenticular lens plate 52 is held by the frame 53 while being forced from the viewer side against the Fresnel lens sheet 51 by the retaining members 57 to 60.

The rear projection screen 111B of such construction is used in, for example, the projection display apparatus 110 shown in FIG. 7. In the projection display apparatus 110, the light beam 115 emitted from the projection optical system 112 is reflected from the reflecting mirror 113, and then directed upwardly onto the plane mirror 114. Thereafter, the light beam 115 is reflected from the plane mirror 114, and then enters the rear projection screen 111B. The light beam 115 incident on the rear projection screen 111B is converted into substantially collimated light by the Fresnel lens 512 provided on the incident side of the Fresnel lens sheet 51 provided in the screen 111B. The collimated light is vertically refracted and diffused by the vertical lenticular lens 513 provided on the viewer side of the Fresnel lens sheet 51 to enter the horizontal lenticular lens plate 52. The light incident on the horizontal lenticular lens plate 52 is horizontally refracted and diffused to exit to the viewer side.

If the resin substrate is thick as in the conventional Fresnel lens screen, the image degradation due to stray light components has occurred for the following reason. As shown in FIG. 26, the majority of the light beam 115 incident on a Fresnel lens 712 is converted as a proper projected light beam 115a into substantially collimated light by the Fresnel lens 712 and exits to the viewer side to form a real image. However, part of the light beam becomes stray light components 115b traveling in a straight line without being converted into the substantially collimated light. The stray light components 115b are totally reflected from the exit surface of a resin substrate 711. Thereafter, the stray light components 115b are reflected from the Fresnel lens 712, pass through the exit surface of a Fresnel lens screen 71, and exit from the Fresnel lens screen 71 to the viewer side at a position spaced the distance M from the real image. An image resulting from the stray light components 115b is known as a ghost image which is a significant factor contributing to image quality degradation. It will be found also from FIG. 26 that the distance M between the real image and the ghost image is roughly proportional to the thickness m of the Fresnel lens screen 71. If, for example, the resin substrate 712 of the conventional Fresnel lens screen 71 is an acrylic plate having a thickness m of 3 mm, the increase in distance M results in clear recognition of the ghost image components to present the image quality degradation problem.

In this regard, when the resin substrate 711 of the Fresnel lens screen 71 is in the form of a thin sheet made of PET resin and is reduced in thickness, for example, down to m=0.25 mm as in the third preferred embodiment, the distance M is shortened and the ghost image components are more visually inconspicuous. This reduces the image quality degradation due to the stray light components to a negligible level.

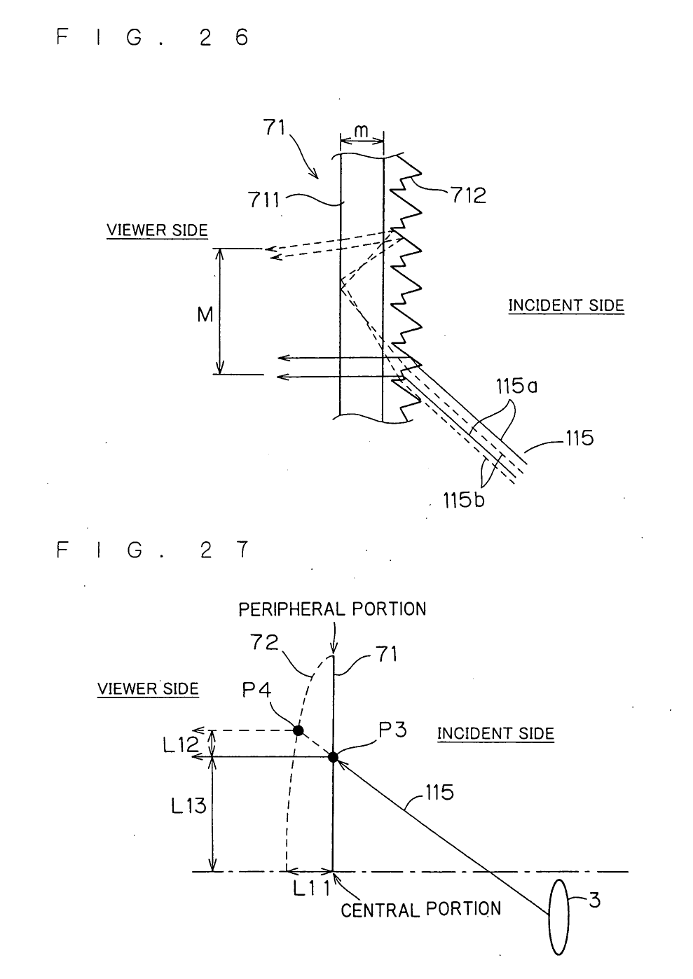

The image quality degradation also occurs because a central portion of the conventional Fresnel lens screen 71 is warped toward the viewer side under the influence of temperature and humidity for the following reason. When the Fresnel lens screen 71 is held to a predetermined degree of flatness, the projected light beam 115 impinges on a normal incident position P3 of the Fresnel lens screen 71, and collimated light exits in a direction indicated by the arrow directed to the viewer side, as shown in FIG. 27. However, if the Fresnel lens screen 71 is influenced by temperature and humidity, maximum warpage. L11 toward the viewer or incident side occurs in the central portion of the Fresnel lens screen 71, as indicated by the broken line 72, for a reason to be described later (although the Fresnel lens screen 71 is shown in FIG. 27 as warped toward the viewer side). The incident position of the light beam 115 upon the Fresnel lens screen 71 accordingly deviates to a position P4, whereby the impingement point of the exiting light beam 115 deviates upwardly by a distance L12.

The deviation of the exiting light beam 115 also occurs in the central portion of the Fresnel lens screen 71 when the projection optical system 112 is located below the central portion of the Fresnel lens screen 71 and the light beam 115 is directed obliquely upwardly onto the screen 71 as in the construction shown in FIG. 7. For example, if the warpage L11 of 3 mm occurs in the central portion of the Fresnel lens screen 71 (where L13=0 mm), the amount of deviation L12 is 3.81 mm in the central portion, and has a maximum value of 4.20 mm at a position spaced the distance L13 of 100 mm apart from the central portion and a minimum value of 0 mm in the peripheral portion of the screen 71 where the distance L13 from the central portion is maximum. Thus, the warpage of the central portion of the Fresnel lens screen 71 under the influence of temperature and humidity causes the maximum deviation of the impingement point of the projected light beam 115 to exceed 4 mm, resulting in significant image quality degradation. Further, variations in spacing between the Fresnel lens screen 71 and the lenticular lens plate 52 causes the image quality degradation known as blurring.

Furthermore, the conventional Fresnel lens screen 71 influenced by temperature and humidity differences has been warped for the following reason. Discussion will be made in the case where the resin substrate 711 of the conventional Fresnel lens screen 71 is an acrylic plate having a thickness m of 3 mm, and a metal frame made of an aluminum alloy is directly mounted to the four sides of the Fresnel lens screen 71. At room temperature (20° C.), the length of the four sides of the Fresnel lens screen 71 is equal to the length of the mounting portion of the metal frame, and the Fresnel lens screen 71 is mounted without warpage. However, the coefficient of linear expansion of the acrylic plate is 80×10⁻⁶/K whereas the coefficient of linear expansion of the aluminum alloy is 23×10⁻⁶/K. Assuming that the size of the Fresnel lens screen 71 is 1200 mm by 900 mm, a comparison of the amount of thermal expansion on the 1200-mm side between the Fresnel lens screen 71 and the metal frame showed that, at a maximum operation assurance temperature (40° C.) for the projection display apparatus, the Fresnel lens screen 71 was longer by 1.4 mm(=1200 mm×(40−20)° C.×(80−23)×10⁻⁶/K) than the metal frame and that, at a maximum storage temperature (60° C.) in warehouse, the Fresnel lens screen was longer by 2.7 mm(=1200 mm×(60−20)° C.×(80−23)×10⁻⁶/K) than the metal frame. The increase in humidity further increased these differences. This is because the acrylic plate expands when it absorbs moisture although the expansion of the metal frame due to moisture absorption does not occur. In such a case, the four sides of the Fresnel lens screen 71 are fixed to the metal frame having high rigidity, so that the thermal expansion differences are not absorbed by the expansion of the metal frame. Thus, the Fresnel lens screen 71 is warped toward the viewer side by the amount of the difference in the amount of thermal expansion as shown in the example of FIG. 27, resulting in the image quality degradation.

To avoid this, the resin substrate 511 of the Fresnel lens sheet 51 according to the third preferred embodiment employs, for example, a PET sheet having a thickness m of 0.25 mm. The coefficient of linear expansion of the PET sheet is 15×10⁻⁶/K which is similar to the coefficient of linear expansion of 23×10⁻⁶/K of the aluminum alloy. For example, a comparison of the amount of thermal expansion on the 1200-mm side between the Fresnel lens sheet 51 and the frame 53 when temperature is changed from room temperature (20° C.) shows that, at the maximum operation assurance temperature (40° C.), the Fresnel lens sheet 51 is shorter by 0.2 mm (=1200 mm×(40−20)° C.×(23−15)×10⁻⁶/K) than the frame 53 and that, at the maximum storage temperature (60° C.) in warehouse, the Fresnel lens sheet 51 is shorter by 0.4 mm(=1200 mm×(60−20)° C.×(23−15)×10⁻⁶/K) than the frame 53. In either case, the Fresnel lens sheet 51 is tensioned by the highly rigid frame 53. This causes no warpage of the Fresnel lens sheet 51 to eliminate the image quality degradation due to warpage. This degree of tension does not exceed the tensile strength of the PET sheet to cause no rupture of the Fresnel lens sheet 51.

Additionally, at a minimum operation assurance temperature (10° C.), the Fresnel lens sheet 51 is longer by 0.1 mm(=1200 mm×(20−10)° C.×(23−15)×10⁻⁶/K) than the frame 53. At a minimum storage temperature (−20° C.) in warehouse, the Fresnel lens sheet 51 is longer by 0.4 mm(=1200 mm×(20−(−20))° C.×(23−15)×10⁻⁶/K) than the frame 53. As far as the difference in the amount of thermal shrinkage is as small as the above, a holding structure in which the elastic members 54 to 56 are used to mount the Fresnel lens sheet 51 to the frame 53 and the elastic members 54 to 56 tension the periphery of the Fresnel lens sheet 51 can eliminate the warpage of the Fresnel lens sheet 51. This also eliminates the image quality degradation due to warpage.

As described above, the use of the PET sheet for the resin substrate 511 of the Fresnel lens sheet 51 achieves the elimination of the image quality degradation due to warpage over a wide temperature range from the minimum storage temperature (−20° C.) in warehouse through room temperature (20° C.) to the maximum storage temperature (60° C.) in warehouse. Additionally, because the PET sheet absorbs moisture little enough to be neglected as compared with the acrylic plate, the image quality degradation due to warpage resulting from temperature and humidity is eliminated.

In the third preferred embodiment, the catch portions 515 to 517 of the Fresnel lens sheet 51 and the elastic members 54 to 56 are held together only by engagement therebetween. The catch portions 514 to 517 of the Fresnel lens sheet 51 are slidable in the longitudinal directions of the catch portions 514 to 517 at portions contacting the elastic members 54 to 56. Thus, the sliding of the catch portions 514 to 517 relieves the differences in the amounts of the expansion and shrinkage resulting from a change in temperature and humidity between the Fresnel lens sheet 51 and the frame 53. The result is the elimination of the image quality degradation due to warpage resulting from temperature and humidity. For similar reasons, the third preferred embodiment removes wrinkles in the early stage of assembly during the mounting of the Fresnel lens sheet 51 to the frame 53, thereby eliminating the image quality degradation due to the wrinkles in the early stage of assembly.

Likewise, the upper catch portion 514 of the Fresnel lens sheet 51 and the engagement surface 535a on the edge of the hook portion 535 of the frame 53 are slidable relative to each other. This eliminates the image quality degradation due to warpage resulting from the expansion difference made by temperature and humidity between the Fresnel lens sheet 51 and the frame 53, and the image quality degradation due to the wrinkles in the early stage of assembly.

As described above, because the Fresnel lens sheet 51 is in the form of the thin sheet of resin, the third preferred embodiment reduces the influence of stray light due to undesired reflection in the Fresnel lens sheet 51 to improve image quality.

Thinning the Fresnel lens sheet 51 reduces the coefficient of linear expansion of the Fresnel lens sheet 51 down to as low as that of metal. Consequently, the third preferred embodiment prevents the image quality degradation due to the influence of warpage of the Fresnel lens sheet 51 resulting from the thermal expansion difference between the metal frame 53 and the Fresnel lens sheet 51.

Because the vertical lenticular lens 513 of the Fresnel lens sheet 51 has a one-piece configuration, the vertical lenticular lens 513 can vertically diffuse the projected light beam 115. Additionally, the effect of reducing the number of parts is produced.

The elastic members 54 to 56 always apply tension in the vertical and horizontal directions of the Fresnel lens sheet 51. This eliminates the image quality degradation due to the vertical and horizontal warpage of the Fresnel lens sheet 51 caused by the thermal expansion difference between the Fresnel lens sheet 51 and the frame 53 under the influence of temperature and humidity and due to the vertical and horizontal wrinkles caused in the early stage of assembly of the Fresnel lens sheet 51 low in rigidity.

Assembly is easily performed only by bringing the upper, lower, left-hand and right-hand catch portions 514 to 517 of the Fresnel lens sheet 51 into engagement with the hook portion 535 of the frame 53 and the elastic members 54 to 56.

The catch portions 514 to 517 of the Fresnel lens sheet 51 are formed by bending the edge portions on the upper, lower, left-hand and right-hand sides of the sheet 51. Therefore, the catch portions 514 to 517 are easily formed.

The edge portions of the catch portions 514 to 517 of the Fresnel lens sheet 51 are bent so as to be substantially parallel to the engagement surface 535a on the edge of the hook portion 535 and the locking portions 542, 552 and 562 of the elastic members 54 to 56. This makes the catch portions 514 to 517 difficult to disengage, and applies tension of the elastic members 54 to 56 to the inner peripheral portions of the catch portions 515 to 517 in a stable manner. As a result, the image quality degradation due to the warpage of the Fresnel lens sheet 51 is prevented.

The catch portions 514 to 517 of the Fresnel lens sheet 51 are held slidably in the longitudinal directions thereof relative to the hook portion 535 and the elastic members 54 to 56. This reliably prevents the vertical and horizontal warpage of the Fresnel lens sheet 51 resulting from the thermal expansion difference between the Fresnel lens sheet 51 and the frame 53 under the influence of temperature and humidity, thereby to eliminate the image quality degradation due to the warpage.

The elastic members 54 to 56 extend along the lower, left-hand and right-hand sides of the Fresnel lens sheet 51 to be engaged therewith so as to cover substantially the entire lengths of the lower, left-hand and right-hand sides (the catch portions 515 to 517) of the Fresnel lens sheet 51. Thus, the elastic members 54 to 56 can apply uniform tension to the lower, left-hand and right-hand sides of the Fresnel-lens sheet 51 along the entire lengths thereof. This prevents the image quality degradation due to the warpage of the Fresnel lens sheet 51 resulting from variations in tension.

The locking portions 542, 552 and 562 of the elastic members 54 to 56 apply tension the magnitude of which is substantially proportional to the amounts of deflection thereof (the variations in deflection angles θ54 and θ55) to the Fresnel lens sheet 51. Therefore, the magnitude of tension applied to the Fresnel lens sheet 51 by the elastic members 54 to 56 is easily set to a value appropriate to the mechanical characteristics of the resin substrate 511 of the Fresnel lens sheet 51.

Although PET is used herein as the material of the resin substrate 511 of the Fresnel lens sheet 51, the resin substrate 511 may be made of any other resin including polystyrene, polycarbonate, acrylic, cyclo-olefin polymer (COP) and the like.

The vertical lenticular lens 513 and the horizontal lenticular lens 522 are formed herein by the rolling process of the UV curable acrylic resin. However, any other resin may be used, and any other molding, forming or extrusion process may be used.

The bending angle of the upper catch portion 514 of the Fresnel lens sheet 51 need not be designed so that the catch portion 514 is substantially parallel to the engagement surface 535a on the edge of the hook portion 535 but may be any degree angle, unless the catch portion 514 is disengaged from the hook portion 535.

The bending angle of the left-hand and right-hand catch portions 516 and 517 of the Fresnel lens sheet 51 need not be designed so that the catch portions 516 and 517 are substantially parallel to the locking portions 552 and 562 of the elastic members 55 and 56, respectively, but may be any degree angle, unless the catch portions 516 and 517 are disengaged from the elastic members 55 and 56.

Although beryllium copper is used herein as an example of the material of the elastic members 54 to 56, any other material including phosphor bronze, stainless and the like may be used to form the elastic members 54 to 56.

The elastic members 54 to 56 may be of any configuration which provides a predetermined spring force.

The elastic members 54 to 56 may be of any thickness which provides a predetermined spring force.

Although an aluminum alloy (or aluminum) is used herein as an example of the material of the frame 53, the frame 53 may be made of any other metal including stainless, iron and the like or made of a highly rigid non-metallic material.

Any combination of the material of the frame 53 and the material of the resin substrate 511 of the Fresnel lens sheet 51 may be used if both of the materials have coefficients of linear expansion close to each other.

### Fourth Preferred Embodiment

A rear projection screen according to a fourth preferred embodiment of the present invention is provided by performing a frictional resistance reduction process on contact portions between the catch portions 514 to 517 of the Fresnel lens sheet 51, and the hook portion 535 and the elastic members 54 to 56 in the rear projection screen 111B of the third preferred embodiment. Specifically, the entire lengths of contact surfaces B1 to B3 (See FIGS. 20, 22 and 23) of inner peripheral portions of the catch portions 515 to 517 of the Fresnel lens sheet 51 with the elastic members 54 to 56 are Teflon® coated. The entire length of the engagement surface 535a of the hook portion 535 is also Teflon® coated. Other constructions of the rear projection screen according to the fourth preferred embodiment are similar to those of the rear projection screen 111B according to the third preferred embodiment.

This reduces the frictional resistance of the contact portions between the catch portions 514 to 517 of the Fresnel lens sheet 51, and the hook portion 535 and the elastic members 54 to 56, to allow the catch portions 514 to 517 to easily slide relative to the hook portion 535 and the elastic members 54 to 56 depending on the expansion and shrinkage of the sheet 51. This reliably eliminates the image quality degradation due to the warpage of the Fresnel lens sheet 51 resulting from the thermal expansion difference between the Fresnel lens sheet 51 and the frame 53 under the influence of temperature and humidity. Additionally, the fourth preferred embodiment can eliminate the wrinkles and warpage of the Fresnel lens sheet 51 by the use of a small tension, to reduce the required spring force of the elastic members 54 to 56, thereby increasing the design flexibility of the elastic members 54 to 56.

To reduce the frictional resistance, any other method may be used if the reduction in friction is accomplished at the contact surfaces of the inner peripheral portions of the catch portions 514 to 517 of the Fresnel lens sheet 51. Examples of such a method include increasing the surface roughness of the contact surfaces, attaching a low-friction material to the contact surfaces, greasing the contact surfaces, and the like.

### Fifth Preferred Embodiment

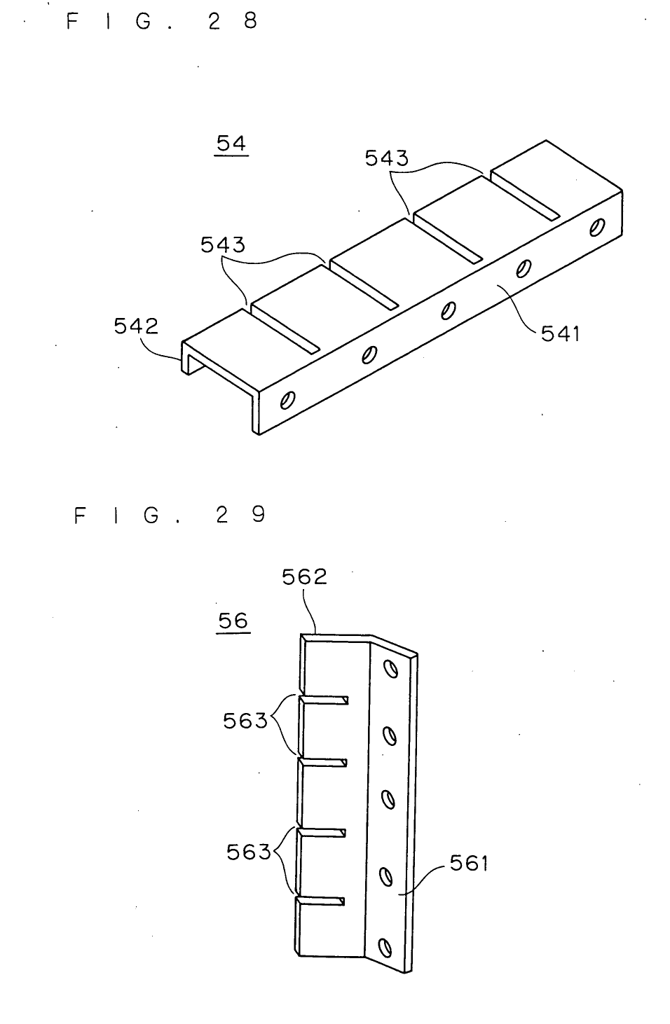

FIGS. 28 and 29 are perspective views of the lower and right-hand elastic members, respectively, for use in a rear projection screen according to a fifth preferred embodiment of the present invention.

As illustrated in FIGS. 28 and 29, portions (viewer-side portions) of the lower and right-hand elastic members 54 and 56 which are closer to the viewer than the fixed portions 541 and 561 are provided with a plurality of slits 543 and a plurality of slits 563, respectively, extending substantially perpendicular to the longitudinal direction of the elastic members 54 and 56 according to the fifth preferred embodiment. The plurality of slits 543 divide the viewer-side portion of the elastic member 54 inclusive of the locking portion 542 into a plurality of sections. Likewise, the plurality of slits 563 divide the viewer-side portion of the elastic member 56 inclusive of the locking portion 562 into a plurality of sections. The width of the slits 543 and 563 is set so as to be small relative to the entire length of the elastic members 54 and 56. Although not shown, the left-hand elastic member 55 is provided with a plurality of slits similar to those of the right-hand elastic member 56. Other constructions of the rear projection screen according to the fifth preferred embodiment are similar to those of the rear projection screen 111B according to the third preferred embodiment.

If the configuration, e.g. linearity, of the contact portions of the inner peripheral portions of the catch portions 515 to 517 of the Fresnel lens sheet 51 with the elastic members 54 to 56 are less precise, the plurality of sections of the locking portions 542, 552 and 562 of the elastic members 54 to 56 individually conform to the configuration of the contact portions to come in contact with the contact portions. This enables the entire lengths of the elastic members 54 to 56 to always contact the inner peripheral portions of the catch portions 515 to 517. Therefore, the spring force of the elastic members 54 to 56 along their entire lengths is always applied to the inner peripheral portions of the catch portions 515 to 517 of the Fresnel lens sheet 51. Because the width of the slits 543 is 563 are small relative to the entire length of the elastic members 54 to 56, the reduction in spring force under the influence of the slits 543 and 563 is negligible. Thus, the fifth preferred embodiment accomplishes a screen holding structure free of image quality degradation due to warpage even if the configuration of the catch portions 515 to 517 of the Fresnel lens sheet 51 is less precise.

The size, configuration and number of slits 543 and 563 are not particularly limited if a predetermined capability thereof is ensured.

The slits 543 and 563 need not be equidistantly spaced relative to each other, but may be formed in any position depending on the precision of the configuration of the catch portions 515 to 517 of the Fresnel lens sheet 51.

### Sixth Preferred Embodiment

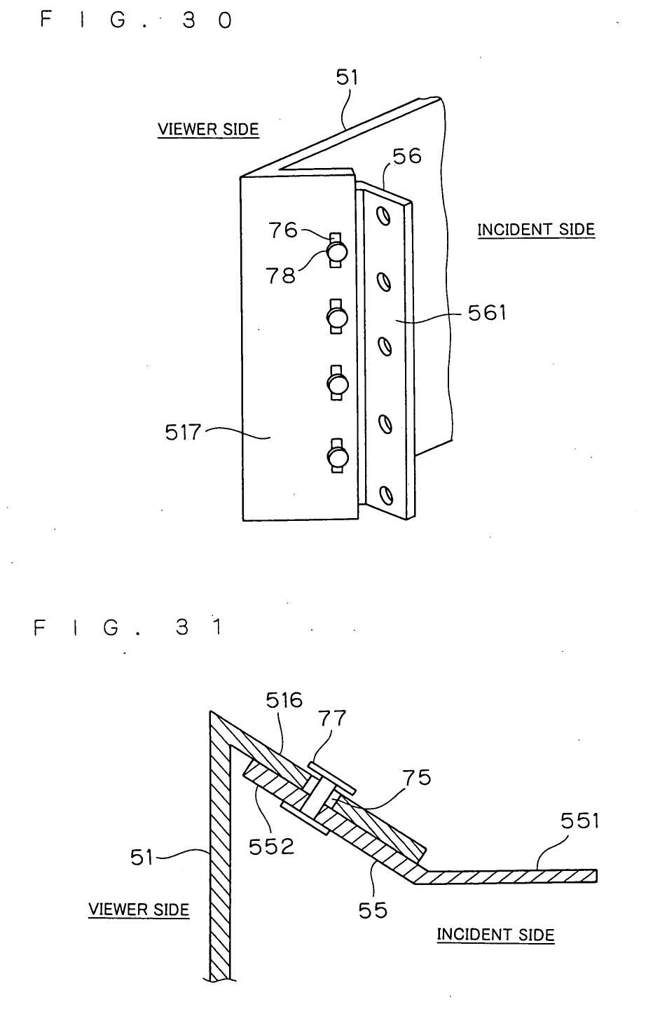

FIG. 30 is a perspective view showing the construction of a right-hand mounting portion of the Fresnel lens sheet 51 in a rear projection screen according to a sixth preferred embodiment of the present invention. FIG. 31 is a sectional view showing the construction of a left-hand mounting portion thereof.

As illustrated in FIGS. 30 and 31, the catch portions 516 and 517 of the Fresnel sheet 51 according to the sixth preferred embodiment are provided with a plurality of slots 75 and a plurality of slots 76, respectively, extending in the longitudinal directions of the catch portions 516 and 517. The slots 75 and 76 receive respective fastening members 77 and 78 serving as a fixture for mounting to the elastic members 55 and 56. The fastening members 77 and 78 are inserted in the slots 75 and 76 so as not to come off, and mounted to the elastic members 55 and 56. Thus, the catch portions 516 and 517 are in engagement with the elastic members 55 and 56 so as to be prevented from being removed from the elastic members 55 and 56 and so as to be slidable in the longitudinal directions thereof. An arrangement similar to that of the slots 75, 76 and the fastening members 77, 78 may be provided in portions for engagement between the catch portions 514, 515, and the hook portion 535 and the elastic member 54. Other constructions of the rear projection screen according to the sixth preferred embodiment are similar to those of the rear projection screen 111B according to the third preferred embodiment.

Such an arrangement makes the locking portions 552 and 562 of the elastic members 55 and 56 difficult to remove from the catch portions 516 and 517 of the Fresnel lens sheet 51, and causes the spring force of the elastic members 55 and 56 to be always applied to the inner peripheries of the catch portions 516 and 517 of the Fresnel lens sheet 51. This accomplishes a screen holding structure free of image quality degradation due to the warpage of the Fresnel lens sheet 51.

The size, configuration and number of slots 75, 76 and fastening members 77, 78 are not particularly limited.

The slots 75, 76 and the fastening members 77, 78 need not be equidistantly spaced relative to each other, but may be formed in any position.

The slots 75, 76 and the fastening members 77, 78 may be arranged in a plurality of lines, as required.

### Seventh Preferred Embodiment

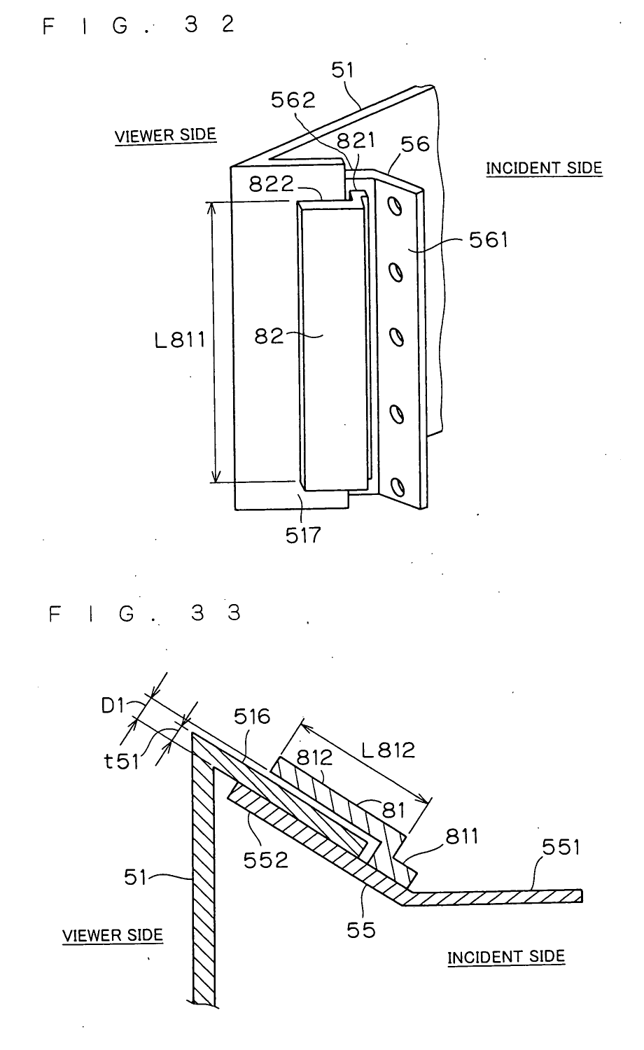

FIG. 32 is a perspective view showing the construction of the right-hand mounting portion of the Fresnel lens sheet 51 in a rear projection screen according to a seventh preferred embodiment of the present invention. FIG. 33 is a sectional view showing the construction of the left-hand mounting portion thereof.

As shown in FIGS. 32 and 33, anti-removal members 81 and 82 are provided on the outer surfaces of edge portions of the elastic members 55 and 56, respectively, according to the seventh preferred embodiment. The anti-removal members 81 and 82 include fixed portions 811 and 821, respectively, fixed on the elastic members 55 and 56. The anti-removal members 81 and 82 further include retaining portions 812 and 822, respectively, which are portions closer to the viewer than the fixed portions 811 and 821. The retaining portions 812 and 822 extend in cantilevered fashion toward the viewer-side edges of the locking portions 552 and 562 substantially in parallel to the locking portions 552 and 562, with a predetermined spacing D1 therebetween. The entire length L811 of the retaining portions 812 and 822 of the anti-removal members 81 and 82 is slightly less than the entire length of the elastic members 55 and 56. The catch portions 516, 517 of the Fresnel lens sheet 51 are inserted between the locking portions 552, 562 of the elastic members 55, 56 and the retaining portions 812, 822, and are engaged with the locking portions 552, 562 while being held therebetween. If the catch portions 516, 517 of the Fresnel lens sheet 51 are about to separate and remove from the locking portions 552, 562, the retaining portions 812, 822 retain the catch portions 516, 517 toward the locking portions 552, 562 to prevent the removal of the catch portions 516, 517. The spacing D1 between the retaining portions 812, 822 and the locking portions 552, 562 is slightly greater than the thickness t51 of the catch portions 516, 517 so as not to obstruct the sliding movement of the catch portions 516, 517. Other constructions of the rear projection screen according to the seventh preferred embodiment are similar to those of the rear projection screen 111B according to the third preferred embodiment.

The anti-removal members 81 and 82 make the locking portions 552 and 562 of the elastic members 55 and 56 difficult to remove from the catch portions 516 and 517 of the Fresnel lens sheet 51, and cause the spring force of the elastic members 55 and 56 to be always applied to the inner peripheries of the catch portions 516 and 517 of the Fresnel lens sheet. This accomplishes a screen holding structure free of image quality degradation due to the warpage of the Fresnel lens sheet 51.

The entire length L811 of the anti-removal members 81 and 82 is not particularly limited if the anti-removal feature is achieved.

The spacing D1 between the locking portions 552, 562 and the retaining portions 812, 822 may have any value if the anti-removal feature is achieved.

The width L812 of the retaining portions 812, 822 of the anti-removal members 81, 82 may have any value if the anti-removal feature is achieved.

Other dimensions, e.g. thickness, and configuration of the anti-removal members 81, 82 are not particularly limited if the anti-removal feature is achieved.

The anti-removal members 81 and 82 may be made of any material if the anti-removal feature is achieved.

The anti-removal members 81 and 82 need not extend along the entire lengths of the elastic members 55 and 56 but may extend along parts thereof. Additionally, each of the anti-removal members 81 and 82 may be divided into a plurality of sections.

The anti-removal members 81 and 82 may be provided on the elastic member 54 for engagement with the lower side of the Fresnel lens sheet 51.

The anti-removal members 81 and 82 may be provided on the hook portion 535 of the frame 53 for engagement with the upper side of the Fresnel lens sheet 51.

While the invention has been described in detail, the foregoing description is in all aspects illustrative and not restrictive. It is understood that numerous other modifications and variations can be devised without departing from the scope of the invention.

What is claimed is:

1. A rear projection screen for allowing a projected light beam incident thereon to pass therethrough to a viewer side, comprising:
a horizontal lenticular lens plate;
a Fresnel lens sheet including a first resin substrate, and a Fresnel lens formed on a first surface of said first resin substrate and serving to concentrate said projected light beam on said viewer side, said Fresnel lens sheet being located on an incident side of said horizontal lenticular lens plate, said incident side being the side from which said projected light beam is incident on said rear projection screen; and
a securing fixture for fixing said Fresnel lens sheet and said horizontal lenticular lens plate together,
said horizontal lenticular lens plate including
a substrate member in plate-like form made of a highly rigid, light-transmittable material, and
a horizontal lenticular lens sheet including a second resin substrate, and a horizontal lenticular lens formed on a first surface of said second resin substrate and serving to horizontally refract incident light, said horizontal lenticular lens sheet being disposed in superposed relation with said substrate member.

2. The rear projection screen according to claim 1, wherein
said Fresnel lens includes a plurality of refraction and total reflection structures including concentric refraction Fresnel lens portions and concentric total reflection Fresnel lens portions, respectively;
each of said refraction Fresnel lens portions includes a combination of a refraction slope for refracting said projected light beam, and an inoperative facet located adjacent to said refraction slope; and
each of said total reflection Fresnel lens portions includes a combination of a transparent slope allowing said projected light beam to pass through, and a total reflection slope for totally reflecting said projected light beam having passed through said transparent slope.

3. The rear projection screen according to claim 1, wherein
said Fresnel lens includes a plurality of concentric total reflection Fresnel lens portions; and
each of said total reflection Fresnel lens portions includes a combination of a transparent slope allowing said projected light beam to pass through, and a total reflection slope for totally reflecting said projected light beam having passed through said transparent slope.

4. The rear projection screen according to claim 1, wherein
said Fresnel lens includes a plurality of concentric refraction Fresnel lens portions; and
each of said refraction Fresnel lens portions includes a combination of a refraction slope for refracting said projected light beam, and an inoperative facet located adjacent to said refraction slope.

5. The rear projection screen according to claim 1, wherein
said Fresnel lens is located on said incident side of said Fresnel lens sheet; and
a vertical lenticular lens serving to vertically refract incident light is formed on said viewer side of said Fresnel lens sheet.

6. The rear projection screen according to claim 1, wherein
said substrate member is made of glass.

7. The rear projection screen according to claim 1, wherein
said substrate member is made of a highly rigid resin.

8. The rear projection screen according to claim 1, wherein
said securing fixture is made of metal.

9. The rear projection screen according to claim 1, wherein
said securing fixture is made of a highly rigid resin.

10. The rear projection screen according to claim 1, wherein
said securing fixture and said resin substrate of said Fresnel lens sheet are made of materials having coefficients of linear expansion close to each other.

11. The rear projection screen according to claim 1, wherein
a light diffusing material is mixed in said substrate member of said horizontal lenticular lens plate.

12. The rear projection screen according to claim 1, wherein
a light diffusing material is mixed in a bonding layer for bonding together said substrate member and said horizontal lenticular lens sheet of said horizontal lenticular lens plate.

13. The rear projection screen according to claim 1, wherein
said horizontal lenticular lens is located on said incident side of said horizontal lenticular lens plate; and
a plurality of black light-blocking layers in the form of stripes are provided on a flat surface of said horizontal lenticular lens plate facing toward said viewer side, said plurality of black light-blocking layers being in corresponding relation to a plurality of lens portions, respectively, of said horizontal lenticular lens, said plurality of black light-blocking layers being located in other than a region through which light correctly collected by said lens portions passes.

14. The rear projection screen according to claim 1, wherein
a light diffusing material is mixed in said Fresnel lens sheet.

15. The rear projection screen according to claim 1, wherein
at least one surface of said horizontal lenticular lens plate is subjected to at least one of a hard coating process, an antistatic process, and an anti-reflection process.

16. The rear projection screen according to claim 1, wherein
at least one surface of said Fresnel lens sheet is subjected to an anti-reflection process.

17. A projection display apparatus comprising
a rear projection screen as recited in claim 1.
